(19) United States
(12) Patent Application Publication
(10) Pub. No.: US 2024/0349258 A1
(43) Pub. Date: Oct. 17, 2024

(54) ELECTRONIC DEVICE, WIRELESS COMMUNICATION METHOD AND COMPUTER-READABLE STORAGE MEDIUM

(71) Applicant: Sony Group Corporation, Tokyo (JP)

(72) Inventors: Zhikun WU, Beijing (CN); Chen SUN, Beijing (CN)

(73) Assignee: Sony Group Corporation, Tokyo (JP)

(21) Appl. No.: 18/291,599

(22) PCT Filed: Jul. 29, 2022
(86) PCT No.: PCT/CN2022/108765

§ 371 Date: Jan. 24, 2024

(30) Foreign Application Priority Data
Aug. 6, 2021 (CN) 202110901661.1

(51) Int. Cl. H04W 72/0446; H04L 5/00; H04W 28/18

(52) U.S. Cl. CPC H04W 72/0446; H04L 5/0048; H04W 28/18

(57) ABSTRACT

The electronic device comprises a processing circuit configured to: determine, according to a period that is sensed by a periodic part, the position of a predetermined time slot to be monitored; according to a data transmission period of the electronic device, determine the position of a time slot that needs to be monitored; and according to the position of the predetermined time slot to be monitored and the position of the time slot that needs to be monitored, determine the position of a time slot to be actually monitored, such that the position of the time slot to be actually monitored comprises the position of the predetermined time slot to be monitored and the position of the time slot that needs to be monitored. Accordingly, sensing schemes can be optimized or improved, a sensing result is more accurate, and collision with other user equipment's resources is reduced.

This application claims priority to Chinese Patent Application No. 202110901661.1 titled “Electronic equipment, wireless communication method and computer-readable storage medium”, filed on Aug. 6, 2021 with the China National Intellectual Property Administration (CNIPA), which is incorporated herein by reference in its entirety.

### FIELD

Embodiments of the present disclosure generally relates to the field of wireless communication, and in particular to electronic equipment, a wireless communication method and a computer-readable storage medium. More particularly, the present disclosure relates to electronic equipment serving as user equipment in a wireless communication system, a wireless communication method performed by user equipment in a wireless communication system, and a computer-readable storage medium.

### BACKGROUND

User equipment may determine resources to be used for sidelink (SL) transmission by sensing, and thereby use the resources to perform communication with other user equipment. Different from a full sensing method, the user equipment may sense whether the resources are free through partial sensing. The partial sensing may include periodic partial sensing and continuous partial sensing. In the periodic partial sensing, the user equipment may perform periodic sensing on a part of time slots. In the continuous partial sensing, the user equipment may perform sensing on a part of consecutive time slots.

However, there are some problems in a conventional partial sensing scheme. For example, in the periodic partial sensing scheme, in a case where a period configured for the user equipment is not matched with a data transmission period of the user equipment, some time slots needed to be listened to may not be listened to, which affect resource selection. In addition, current standards do not discuss how to perform periodic partial sensing in a case where the number of candidate slots is less than a predetermined threshold. Furthermore, in a case that the user equipment uses resources in a manner of periodically occupying the resources, such as semi-persistent scheduling (SPS), resources in another period, other than initial resources, may be used by the user equipment without being sensed, causing a possibility of collision with resources of other user equipment.

Therefore, it is necessary to provide a technical solution to solve at least one of the above problems such that a partial sensing solution is optimized or improved, so that a sensing result is more accurate, and possibility of collision with resources of other user equipment is reduced.

### SUMMARY

This section provides a general summary of the present disclosure, rather than a comprehensive disclosure of a full scope or all features of the present disclosure.

An objective of the present disclosure is to provide electronic equipment, a wireless communication method, and a computer-readable storage medium, with which a partial sensing solution is optimized or improved, so that a sensing result is more accurate, and possibility of collision with resources of other user equipment is reduced.

According to an aspect of the present disclosure, electronic equipment is provided, including processing circuitry configured to: determine a position of a predetermined time slot to be listened to according to a period of periodic partial sensing; determine a position of a time slot needed to be listened to according to a data transmission period of the electronic equipment; and determine a position of a time slot actually to be listened to according to the position of the predetermined time slot to be listened to and the position of the time slot needed to be listened to, so that the position of the time slot actually to be listened to includes the position of the predetermined time slot to be listened to and the position of the time slot needed to be listened to.

According to another aspect of the present disclosure, electronic equipment is provided, including processing circuitry configured to: determine, in a case where the number of candidate time slots in a resource selection window is less than a predetermined threshold, a position of a time slot to be listened to according to positions of the candidate time slots and a period of periodic partial sensing; execute the periodic partial sensing to perform listening at the position of the time slot to be listened to, to determine free resources in the candidate time slots; and determine resources to be used for sidelink transmission from the free resources in the candidate time slots.

According to another aspect of the present disclosure, electronic equipment is provided, including processing circuitry configured to: reuse, in each data transmission period, periodically occupied resources for sidelink transmission; perform, before reusing the periodically occupied resources in part of the data transmission periods, a resource occupancy check on the periodically occupied resources to determine whether the periodically occupied resources are free; and in the other part of the data transmission periods, perform no resource occupancy check on the periodically occupied resources, and generate information indicating that the electronic equipment performs no resource occupancy check on the periodically occupied resources, or increase a priority of data packets sent by reusing the periodically occupied resources.

According to another aspect of the present disclosure, a wireless communication method performed by electronic equipment is provided, including: determining a position of a predetermined time slot to be listened to according to a period of periodic partial sensing; determining a position of a time slot needed to be listened to according to a data transmission period of the electronic equipment; and determining a position of a time slot actually to be listened to according to the position of the predetermined time slot to be listened to and the position of the time slot needed to be listened to, so that the position of the time slot actually to be listened to includes the position of the predetermined time slot to be listened to and the position of the time slot needed to be listened to.

According to another aspect of the present disclosure, a wireless communication method performed by electronic equipment is provided, including: determining, in a case where the number of candidate time slots in a resource selection window is less than a predetermined threshold, a position of a time slot to be listened to according to positions of the candidate time slots and a period of periodic partial sensing; performing the periodic partial sensing to perform listening at the position of the time slot to be listened to, to determine free resources in the candidate time slots; and determining resources to be used for sidelink transmission from the free resources in the candidate time slots.

According to another aspect of the present disclosure, a wireless communication method performed by electronic equipment is provided, including: reusing, in each data transmission period, periodically occupied resources for sidelink transmission; performing, before reusing the periodically occupied resources in part of the data transmission periods, a resource occupancy check on the periodically occupied resources to determine whether the periodically occupied resources are free; and in the other part of the data transmission periods, performing no resource occupancy check on the periodically occupied resources, and generating information indicating that the electronic equipment performs no resource occupancy check on the periodically occupied resources, or increasing a priority of data packets sent by reusing the periodically occupied resources.

According to another aspect of the present disclosure, a computer-readable storage medium including executable computer instructions is provided. The executable computer instructions, when executed by a computer, cause the computer to perform the wireless communication method according to the present disclosure.

According to another aspect of the present disclosure, a computer program is provided. The computer program, when executed by a computer, causes the computer to perform the wireless communication method according to the present disclosure.

With the electronic equipment, the wireless communication method, and the computer-readable storage medium according to the present disclosure, the position of the predetermined time slot to be listened to can be determined according to the period of the periodic partial sensing, and the position of the time slot needed to be listened to is determined according to the data transmission period of the electronic equipment. Thereby, the position of the time slot actually to be listened to is determined to include the above-mentioned two positions. In this way, in a case where the position of the predetermined time slot to be listened to does not completely include the position of the time slot needed to be listened to, the electronic equipment may perform listening on a time slot that is not included, so that a result of the listening is more accurate and the resource selection is more accurate.

Furthermore, with the electronic equipment, the wireless communication method and the computer-readable storage medium according to the present disclosure, in a case where the number of candidate time slots is less than the predetermined threshold, the electronic equipment can determine the position of the time slot to be listened to according to the positions of the candidate time slots, and thereby select resources from the candidate time slots. In this way, the periodic partial sensing can be realized in a case where the number of candidate slots is less than a predetermined threshold.

In addition, with the electronic equipment, the wireless communication method and the computer-readable storage medium according to the present disclosure, in a case where the electronic equipment uses the resources in a manner of periodically occupying the resources, the electronic equipment can perform resource occupancy check on the resources before reusing the periodically occupied resources in part of the data transmission periods, and perform no resource occupancy check on the resources before reusing the periodically occupied resources in the other part of the data transmission periods. In the case of no resource occupancy check, the electronic equipment can generate information indicating that the electronic equipment performs no resource occupancy check on the periodically occupied resources, or increase a priority of data packets. In this way, other user equipment learns that the electronic equipment uses the periodically occupied resources without the resource occupancy check, and therefore avoids using the resources; or in a case of resource collision, other user equipment may perform resource re-selection due to the higher priority of the data packets. In summary, the probability of resource collision between the electronic equipment and other user equipment can be reduced.

Further areas of applicability will become apparent from the description provided herein. The description and specific examples in this summary are for purposes of illustration only and are not intended to limit the scope of the present disclosure.

### BRIEF DESCRIPTION OF THE DRAWINGS

The accompanying drawings described herein are only for illustrative purposes of selected embodiments, rather than all possible embodiments, and are not intended to limit the scope of the present disclosure. In the accompanying drawings:

FIG. 1 is a schematic diagram showing a process of full sensing;

FIG. 2 is a schematic diagram showing a process of periodic partial sensing;

FIG. 3 is a schematic diagram showing a process of continuous partial sensing;

FIG. 4 is a schematic diagram showing a process of re-evaluation;

FIG. 5 is a block diagram illustrating an exemplary configuration of electronic equipment according to a first embodiment of the present disclosure;

FIG. 6 is a schematic diagram illustrating a process of determining a time slot actually to be listened to according to a first embodiment of the present disclosure;

FIG. 7 is a schematic diagram illustrating a process of determining a time slot actually to be listened to according to a first embodiment of the present disclosure;

FIG. 8 is a schematic diagram illustrating a process of determining a time slot actually to be listened to according to a first embodiment of the present disclosure;

FIG. 9 is a block diagram illustrating an exemplary configuration of electronic equipment according to a second embodiment of the present disclosure;

FIG. 10 is a schematic diagram illustrating a process of determining resources in a case where the number of candidate time slots is less than a predetermined threshold according to a second embodiment of the present disclosure;

FIG. 11 is a schematic diagram illustrating a process of determining resources in a case where the number of candidate time slots is less than a predetermined threshold according to a second embodiment of the present disclosure;

FIG. 12 is a block diagram illustrating an exemplary configuration of electronic equipment according to a third embodiment of the present disclosure;

FIG. 13 is a schematic diagram illustrating a process of sensing in a case of periodically occupied resources according to a third embodiment of the present disclosure;

FIG. 14 is a schematic diagram illustrating a process of indicating resources on which no resource occupancy check is performed in a case of periodically occupied resources according to a third embodiment of the present disclosure;

FIG. 15 is a schematic diagram illustrating a process of indicating resources on which no resource occupancy check is performed in a case of periodically occupied resources according to a third embodiment of the present disclosure;

FIG. 16 is a flowchart illustrating a wireless communication method performed by electronic equipment according to an embodiment of the present disclosure;

FIG. 17 is a flowchart illustrating a wireless communication method performed by electronic equipment according to an embodiment of the present disclosure;

FIG. 18 is a flowchart illustrating a wireless communication method performed by electronic equipment according to an embodiment of the present disclosure;

FIG. 19 is a flowchart illustrating a wireless communication method performed by electronic equipment according to an embodiment of the present disclosure;

FIG. 20 is a flowchart illustrating a wireless communication method performed by electronic equipment according to an embodiment of the present disclosure;

FIG. 21 is a flowchart illustrating a wireless communication method performed by electronic equipment according to an embodiment of the present disclosure;

FIG. 22 is a block diagram showing an example of a schematic configuration of a smartphone; and

FIG. 23 is a block diagram showing an example of a schematic configuration of a vehicle navigation device.

Although the present disclosure is easily subjected to various modifications and replacements, specific embodiments thereof, as examples, are shown in the drawings and described in detail here. However, it should be understood that, the description of specific embodiments herein is not intended to limit the present disclosure to specific forms that are disclosed. On the contrary, an object of the present disclosure is to cover all modifications, equivalents and replacements that fall within the spirit and scope of the present disclosure. It should be noted that throughout the several drawings, corresponding components are indicated by corresponding reference numerals.

### DETAILED DESCRIPTION

Examples of the present disclosure are now fully described with reference to the accompanying drawings. The following description is merely substantially exemplary and is not intended to limit the present disclosure, an application or use thereof.

Exemplary embodiments are provided so that the present disclosure is described in detail and fully conveys the scope thereof to those skilled in the art. Examples of specific components, apparatus, methods and other specific details are set forth to provide detailed understanding of embodiments of the present disclosure. It will be apparent to those skilled in the art that the exemplary embodiments may be implemented in many different forms without the use of specific details, and they should not be construed as limiting the scope of the present disclosure. In some exemplary embodiments, well-known processes, well-known structures, and well-known technologies are not described in detail.

The description is given in the following order.
1. Description of scenarios;
2. Exemplary configuration of electronic equipment according to a first embodiment
3. Exemplary configuration of electronic equipment according to a second embodiment
4. Exemplary configuration of electronic equipment according to a third embodiment
5. Method embodiment; and
6. Application example.

### 1. Description of Scenarios

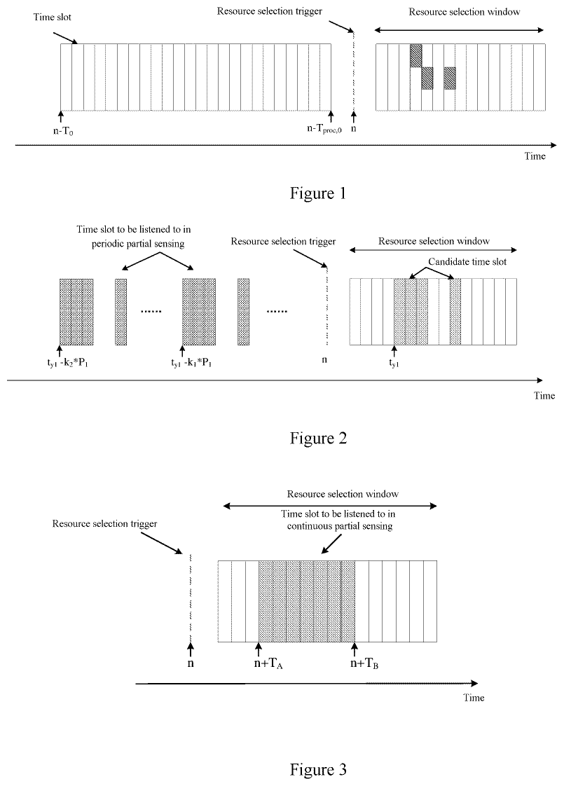

FIG. 1 is a schematic diagram showing a process of full sensing. As shown in FIG. 1, during a period from time instant n−T0 to n−Tproc,0 before a time instant n for resource selection trigger, user equipment may sense whether resources on all consecutive time slots are free, and thereby select resources in a resource selection window for sidelink transmission.

FIG. 2 is a schematic diagram showing a process of periodic partial sensing. As shown in FIG. 2, user equipment may determine one or more candidate time slots in a resource selection window, so as to determine a position of a time slot to be listened to for periodic partial sensing according to the one or more candidate time slots.

FIG. 3 is a schematic diagram showing a process of continuous partial sensing. As shown in FIG. 3, user equipment may perform listening on consecutive time slots between time instant n+T_{A} and n+T_{B} after a time instant n for resource selection trigger. Although FIG. 3 shows a situation where continuous partial sensing is performed on time slots after the time instant for resource selection trigger, the continuous partial sensing is not limited thereto. The continuous partial sensing means that the user equipment performs sensing on part of consecutive time slots in a non-periodic manner.

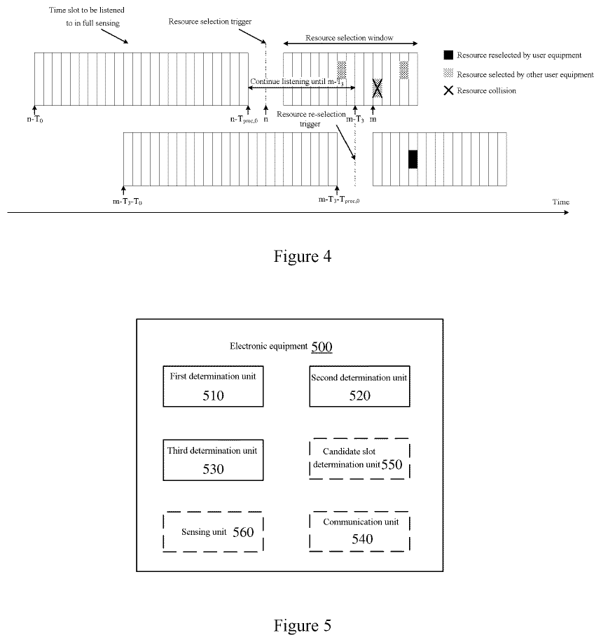

FIG. 4 is a schematic diagram showing a process of re-evaluation/resource occupancy check. As shown in FIG. 4, before a time instant n for resource selection trigger, user equipment determines, through full sensing, that resources at time instant m are free and determines to user the resources for sidelink transmission. Then, the user equipment may continue to listen to the channel until time instant m−T₃. In a case that the channel collides with resources selected by other user equipment and data packets to be sent by other user equipment have a higher priority, the user equipment triggers a resource re-selection process and reselects a free resource. The re-evaluation/resource occupancy check here may be implemented through continuous partial sensing, that is, sensing resources on part of consecutive time slots.

As mentioned above, in the periodic partial sensing scheme, the user equipment determines a position of a time slot to be listened to, according to K and P indicated by network side equipment. However, in a case where a data transmission period of the user equipment is not matched with P, some time slots needed to be listened to may not be listened to, which affect resource selection. In addition, current standards do not discuss how to perform periodic partial sensing in a case where the number of candidate slots is less than a predetermined threshold. Furthermore, in a case that the user equipment uses resources in a manner of periodically occupying the resources, other resources except for initial resources may be used by the user equipment without being sensed, causing a possibility of collision with resources of other user equipment.

The present disclosure provides electronic equipment in a wireless communication system, a wireless communication method performed by the electronic equipment in the wireless communication system, and a computer-readable storage medium, with which a partial sensing solution is optimized or improved, so that a sensing result is more accurate, and possibility of collision with resources of other user equipment is reduced.

The wireless communication system according to the present disclosure may be a 5G NR (New Radio) communication system. With the development of technology, the wireless communication system according to the present disclosure may be a higher-level communication system.

The network side equipment according to the present disclosure may be station equipment, such as gNB or eNB.

The user equipment according to the present disclosure may be a mobile terminal (such as a smartphone, a tablet personal computer (PC), a notebook PC, a portable game terminal, a portable/dongle-type mobile router, and a digital camera), or an in-vehicle terminal (such as a vehicle navigation device). The user equipment may also be implemented as a terminal that performs machine-to-machine (M2M) communication (which is also referred to as a machine type communication (MTC) terminal). Furthermore, the user equipment may be a wireless communication module (such as an integrated circuit module including a single wafer) installed on each of the above-mentioned terminals.

User equipment according to the present disclosure may communicate with each other in a D2D manner. Links between user equipment may be referred to as sidelink. Furthermore, in D2D communication between user equipment, the user equipment at a sender may adopt a resource allocation method of mode 2, that is, the user equipment at the sender determines resources for the D2D communication by itself, without resource allocation by network side equipment.

User equipment according to the present disclosure can have a sensing capability, that is, the user equipment can determine whether resources are free by listening to a channel, and thereby use the free resources for D2D communication.

### 2. Exemplary Configuration of Electronic Equipment According to a First Embodiment

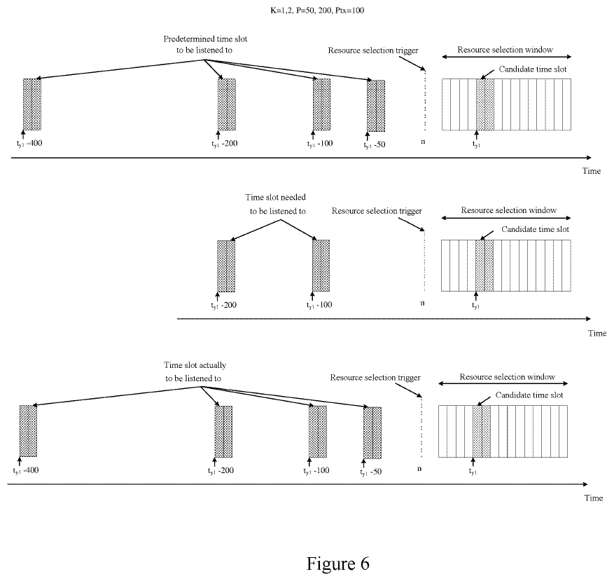

FIG. 5 is a block diagram illustrating an exemplary configuration of electronic equipment 500 according to a first embodiment of the present disclosure. The electronic equipment 500 here may serve as user equipment in a wireless communication system, and specifically may be user equipment serving as a sender in D2D communication.

As shown in FIG. 5, the electronic equipment 500 may include a first determination unit 510, a second determination unit 520 and a third determination unit 530.

Here, units of the electronic equipment 500 may be included in processing circuitry. It should be noted that the electronic equipment 500 may include a single processing circuit or multiple processing circuits. Further, the processing circuitry may include various discrete functional units for performing various different functions and/or operations. It should be noted that these functional units may be physical entities or logical entities, and units with different names may be implemented by a same physical entity.

According to an embodiment of the present disclosure, the first determination unit 510 may determine a position of a predetermined time slot to be listened to according to a period of periodic partial sensing.

According to an embodiment of the present disclosure, the second determination unit 520 may determine a position of a time slot needed to be listened to according to a data transmission period of the electronic equipment 500.

According to an embodiment of the present disclosure, the third determination unit 530 may determine a position of a time slot actually to be listened to according to the position of the predetermined time slot to be listened to, determined by the first determination unit 510, and the position of the time slot needed to be listened to, which is determined by the second determination unit 520, so that the position of the time slot actually to be listened to includes the position of the predetermined time slot to be listened to and the position of the time slot needed to be listened to.

It can be seen that with the electronic equipment 500 according to the embodiments of the present disclosure, the position of the predetermined time slot to be listened to can be determined according to the period of the periodic partial sensing, and the position of the time slot needed to be listened to is determined according to the data transmission period of the electronic equipment 500. Thereby, the position of the time slot actually to be listened to is determined to include the above-mentioned two positions. In this way, in a case where the position of the predetermined time slot to be listened to does not completely include the position of the time slot needed to be listened to, the electronic equipment 500 may perform listening on a time slot that is not included, so that a result of the listening is more accurate and the resource selection is more accurate.

According to an embodiment of the present disclosure, as shown in FIG. 5, the electronic equipment 500 may further include a communication unit 540 for sending/receiving information.

According to an embodiment of the present disclosure, the electronic equipment 500 may receive, from network side equipment via the communication unit 540, a period of the periodic partial sensing and a position indication of the periodic partial sensing which are configured by the network side equipment. Here, the network side equipment may be base station equipment serving the electronic equipment 500. Further the first determination unit 510 may determine the position of the predetermined time slot to be listened to according to the period of the periodic partial sensing and the position indication of the periodic partial sensing. That is, the position of the predetermined time slot to be listened to is determined according to a configuration on the network side.

According to an embodiment of the present disclosure, the period of the periodic partial sensing configured by the network side equipment may include one or more periods selected from periods supported by a resource pool. For example, a period P of the periodic partial sensing configured by the network side equipment may be a set including one or more periods, where Pⱼ represents any element in the set P, there has 1≤j≤M and j is an integer, and M represents the number of elements in the set P.

According to an embodiment of the present disclosure, the position indication of the periodic partial sensing configured by the network side equipment includes one or more position indications. For example, a position indication K of the periodic partial sensing configured by the network side equipment may be a set including one or more positive integers. Here, kᵢ represents an element in the set K, there has 1≤i≤N and i is an integer, and N represents the number of elements in the set K.

According to an embodiment of the present disclosure, as shown in FIG. 5, the electronic equipment 500 may further include a candidate time slot determination unit 550, which is configured to determine one or more candidate time slots in a resource selection window. Furthermore, the candidate time slots may be consecutive time slots or non-consecutive time slots.

According to an embodiment of the present disclosure, the first determination unit 510 may determine the position of the predetermined time slot to be listened to according to positions of the candidate time slots, and the period P and the position indication K configured by the network side equipment.

According to an embodiment of the present disclosure, the first determination unit 510 may use, for each candidate time slot, a time slot before the candidate time slot and at a distance from the candidate time slot of a first predetermined number of time slots, as the predetermined time slot to be listened to, the first predetermined number being a result obtained by multiplying the period P of the periodic partial sensing by the position indication K of the periodic partial sensing.

Further, in the case where the period P and/or the position indication K includes multiple elements, the first predetermined number is a result obtained by multiplying each element in the period P by each element in the position indication K. That is, for each candidate time slot, the first determination unit 510 may determine multiple predetermined time slots to be listened to. Specifically, for each candidate time slot, the number of predetermined time slots to be listened to, determined by the first determination unit 510, may be N×M. Apparently, there may be duplicate time slots among the N×M time slots.

For example, in the example shown in FIG. 2, for a candidate time slot t_{y1}, the first determination unit 510 determines a time slot at t_{y1}−kᵢ×Pⱼ as the predetermined time slot to be listened to. Assuming that there is only one element P₁ in P and two elements k₁ and k₂ in K, then for a candidate time slot t_{y1}, the first determination unit 510 determines time slots at t_{y1}−k₁×P₁ and t_{y1}−k₂×P₁ as the predetermined time slot to be listened to. That is, for a candidate time slot, the first determination unit 510 determines two predetermined time slots to be listened to. There are 4 candidate time slots in FIG. 2, and therefore the first determination unit 510 determines two groups of four time slots at the corresponding positions as the predetermined time slots to be listened to.

According to an embodiment of the present disclosure, the second determination unit 520 may determine the position of the time slot needed to be listened to according to a data transmission period of the electronic equipment 500 and the position indication of the periodic partial sensing. That is, the position of the time slot needed to be listened to is determined according to the data transmission period of the electronic equipment 500.

According to an embodiment of the present disclosure, the second determination unit 520 may determine the position of the predetermined time slot to be listened to according to the positions of the candidate time slots, the data transmission period Pₜₓ of the electronic equipment 500 and the position indication K.

According to an embodiment of the present disclosure, the second determination unit 520 may use, for each candidate time slot, a time slot before the candidate time slot and at a distance from the candidate time slot of a second predetermined number of time slots, as the time slot needed to be listened to, the second predetermined number being a result obtained by multiplying the data transmission period Pₜₓ of the electronic equipment 500 by the position indication K of the periodic partial sensing.

Further, in the case where the position indication K includes multiple elements, the second predetermined number is a result obtained by multiplying the data transmission period Pₜₓ of the electronic equipment 500 by each element in the position indication K. That is, for each candidate time slot, the second determination unit 520 may determine multiple time slots needed to be listened to. Specifically, for each candidate time slot, the number of time slots needed to be listened to, determined by the second determination unit 520, may be N.

For example, in the example shown in FIG. 2, for a candidate time slot t_{y1}, the second determination unit 520 determines a time slot at t_{y1}−k₁×Pₜₓ as the predetermined time slot to be listened to. Assuming that there is two elements k₁ and k₂ in K, then for a candidate time slot t_{y1}, the user equipment determines time slots at t_{y1}−k₁×Pₜₓ and t_{y1}−k₂×Pₜₓ as the time slots needed to be listened to.

According to an embodiment of the present disclosure, the third determination unit 530 may determine the position of the time slot actually to be listened to after the position of the predetermined time slot to be listened to is determined by the first determination unit 510 and the position of the time slot needed to be listened to is determined by the second determination unit 520, so that the position of the time slot actually to be listened to includes the position of the predetermined time slot to be listened to and the position of the time slot needed to be listened to.

In other words, the third determination unit 530 may determine whether the position of the predetermined time slot to be listened to completely includes the position of the time slot needed to be listened to. Further, in a case where the position of the predetermined time slot to be listened to completely includes the position of the time slot deeded to be listened to, the third determination unit 530 may determine that the position of the time slot actually to be listened to is the same as the position of the predetermined time slot to be listened to. In a case that the position of the predetermined time slot to be listened to does not completely include the position of the time slot needed to be listened to, the third determination unit 530 may determine a union of the position of the predetermined time slot to be listened to and the position of the time slot needed to be listened to as the position of the time slot actually to be listened to.

According to an embodiment of the present disclosure, as shown in FIG. 5, the electronic equipment 500 may further include a sensing unit 560. The sensing unit 560 is for performing sensing on a channel to determine a free state of resources on the channel. The free state includes but is not limited to free and occupied. Further, the sensing performed by the sensing unit 560 may be full sensing, periodic partial sensing, or continuous partial sensing.

According to an embodiment of the present disclosure, after the third determination unit determines the position of the time slot actually to be listened to, the sensing unit 560 may perform the periodic partial sensing to perform listening at the position of the time slot actually to be listened to. In this way, the electronic equipment 500 may perform sidelink transmission with other user equipment utilizing the free resources.

FIG. 6 is a schematic diagram illustrating a process of determining a time slot actually to be listened to according to a first embodiment of the present disclosure. In FIG. 6, the period P configured on the network side includes two elements, i.e., 50 and 200, in milliseconds. The position indication K configured on the network side includes two elements, i.e., 1 and 2. The data transmission period Pₜₓ of the electronic equipment 500 is 100 milliseconds. Furthermore, for convenience of illustration, FIG. 6 shows an example in which the candidate time slots include two consecutive time slots.

As shown in FIG. 6, for a candidate time slot ty, according to P and K, the position of the predetermined time slot to be listened to, determined by the first determination unit 510, is t_{y1}−50, t_{y1}−100, t_{y1}−200 and t_{y1}−400. Similarly, for the candidate time slots following the candidate time slot t_{y1}, the first determination unit 510 may determine four predetermined time slots to be listened to. Further, for a candidate time slot t_{y1}, according to K and Pₜₓ, the position of time slot needed to be listened to, determined by the second determination unit 520, is t_{y1}−100 and t_{y1}−200. Similarly, for the candidate time slots following the candidate time slot ty, the second determination unit 520 may determine two time slots needed to be listened to. Further, the third determination unit 530 may determine that the position t_{y1}−100 and t_{y1}−200 of the time slot needed to be listened to is completely included in the position of predetermined time slot to be listened to, and therefore may determine that the position of the time slot actually to be listened to is the same as the position of the predetermined time slot to be listened to.

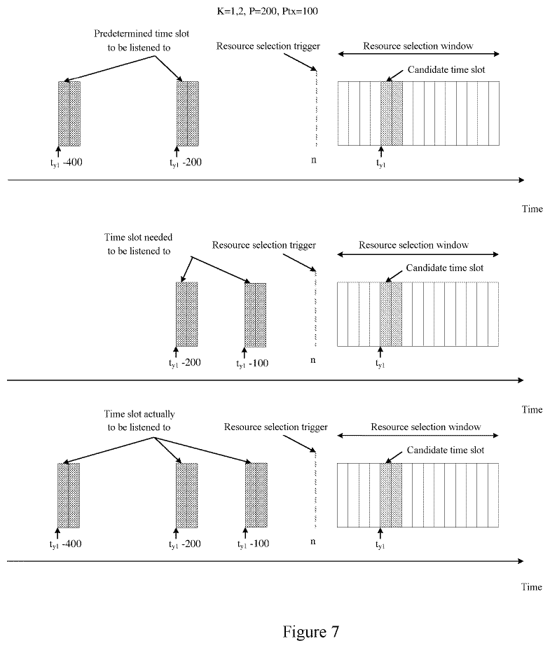

FIG. 7 is a schematic diagram illustrating a process of determining a time slot actually to be listened to according to a first embodiment of the present disclosure. In FIG. 7, the period P configured on the network side includes one element, i.e., 200, in milliseconds. The position indication K configured on the network side includes two elements, i.e., 1 and 2. The data transmission period Pₜₓ of the electronic equipment 500 is 100 milliseconds. Furthermore, for convenience of illustration, FIG. 7 shows an example in which the candidate time slots include two consecutive time slots.

As shown in FIG. 7, for a candidate time slot ty, according to P and K, the position of the predetermined time slot to be listened to, determined by the first determination unit 510, is t_{y1}−200 and t_{y1}−400. Similarly, for the candidate time slots following the candidate time slot t_{y1}, the first determination unit 510 may determine two predetermined time slots to be listened to. Further, for a candidate time slot ty, according to K and Pₜₓ, the position of the time slot needed to be listened to, determined by the second determination unit 520, is t_{y1}−100 and t_{y1}−200. Similarly, for the candidate time slots following the candidate time slot ty, the second determination unit 520 may determine two time slots needed to be listened to. Further, the third determination unit 530 may determine that the position t_{y1}−200 of the time slot needed to be listened to is included in the position of the predetermined time slot to be listened to, and the position t_{y1}−100 of the time slot needed to be listened to is not included in the position of the predetermined time slot to be listened to. That is, the third determination unit 530 may determine that the position of the time slot needed to be listened to is not completely included in the position of the predetermined time slot to be listened to. In this case, the third determination unit 530 may determine that the position of the time slot actually to be listened to includes the position of the predetermined time slot to be listened to and the position of the time slot needed to be listened to, that is, a union of the position of the predetermined time slot to be listened to and the position of the time slot needed to be listened to. As shown in FIG. 7, the position of the time slot actually to be listened to, determined by the third determination unit 530, is t_{y1}−100, t_{y1}−200 and t_{y1}−400. Similarly, for the candidate time slots following the candidate time slot t_{y1}, the third determination unit 530 may determine three time slots actually to be listened to.

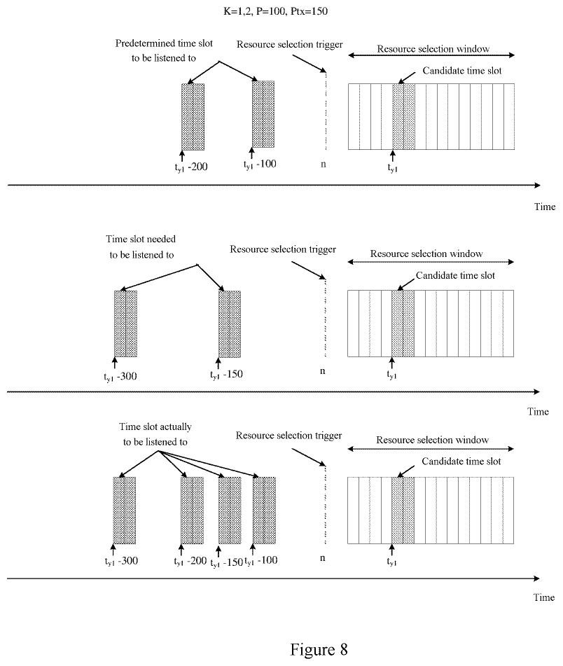

FIG. 8 is a schematic diagram illustrating a process of determining a time slot actually to be listened to according to a first embodiment of the present disclosure. In FIG. 8, the period P configured on the network side includes one element, i.e., 100, in milliseconds. The position indication K configured on the network side includes two elements, i.e., 1 and 2. The data transmission period Pₜₓ of the electronic equipment 500 is 150 milliseconds. Furthermore, for convenience of illustration, FIG. 8 shows an example in which the candidate time slots include two consecutive time slots.

As shown in FIG. 8, for a candidate time slot ty, according to P and K, the position of the predetermined time slot to be listened to, determined by the first determination unit 510, is t_{y1}−100 and t_{y1}−200. Similarly, for the candidate time slots following the candidate time slot t_{y1}, the first determination unit 510 may determine two predetermined time slots to be listened to. Further, for a candidate time slot t_{y1}, according to K and Pₜₓ, the position of the time slot needed to be listened to, determined by the second determination unit 520, is t_{y1}−150 and t_{y1}−300. Similarly, for the candidate time slots following the candidate time slot ty, the second determination unit 520 may determine two time slots needed to be listened to. Further, the third determination unit 530 may determine that the position t_{y1}−150 of the time slot needed to be listened to is not included in the position of the predetermined time slot to be listened to, and the position t_{y1}−300 of the time slot needed to be listened to is also not included in the position of the predetermined time slot to be listened to. That is, the third determination unit 530 may determine that the position of the time slot needed to be listened to is not included in the position of the predetermined time slot to be listened to. In this case, the third determination unit 530 may determine that the position of the time slot actually to be listened to includes the position of the predetermined time slot to be listened to and the position of the time slot needed to be listened to, that is, a union of the position of the predetermined time slot to be listened to and the position of the time slot needed to be listened to. As shown in FIG. 8, the position of the time slot actually to be listened to, determined by the third determination unit 530, is t_{y1}−100, t_{y1}−150, t_{y1}−200 and t_{y1}−300. Similarly, for the candidate time slots following the candidate time slot t_{y1}, the third determination unit 530 may determine four time slots needed to be listened to.

It can be seen that with the electronic equipment 500 according to the embodiments of the present disclosure, the position of the predetermined time slot to be listened to can be determined according to the configuration of the network side equipment, and the position of the time slot needed to be listened to is determined according to the data transmission period of the electronic equipment 500. Thereby, the position of the time slot actually to be listened to is determined to include the above-mentioned two positions. In this way, in a case where the position of the predetermined time slot to be listened to does not completely include the position of the time slot needed to be listened to, the electronic equipment 500 may perform listening on a time slot that is not included, so that the electronic equipment 500 is able to listen to the position of the time slot needed to be listened to. Therefore, a result of the listening is more accurate and the resource selection is more accurate.

### 3. Exemplary Configuration of Electronic Equipment According to a Second Embodiment

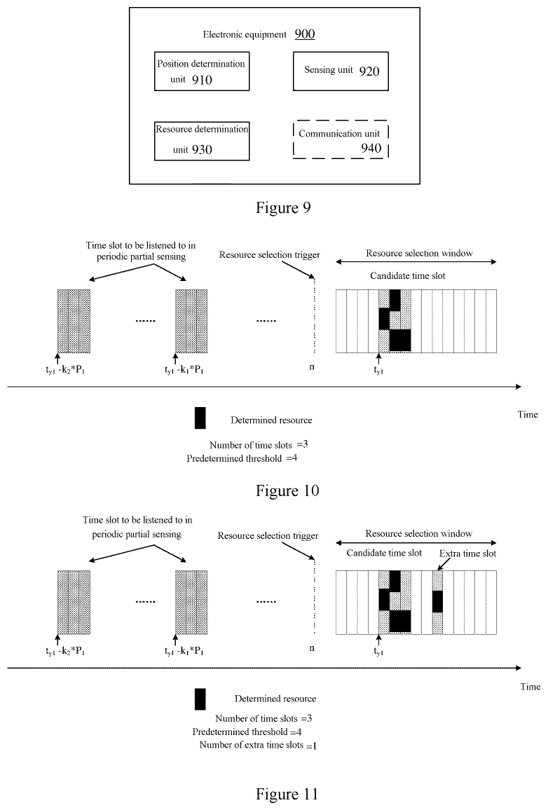

FIG. 9 is a block diagram illustrating a structure of electronic equipment 900 serving as user equipment in a wireless communication system according to a second embodiment of the present disclosure.

As shown in FIG. 9, the electronic equipment 900 may include a position determination unit 910, a sensing unit 920 and a resource determination unit 930.

Here, units of the electronic equipment 900 may be included in processing circuitry. It should be noted that the electronic equipment 900 may include a single processing circuit or multiple processing circuits. Further, the processing circuitry may include various discrete functional units for performing various different functions and/or operations. It should be noted that these functional units may be physical entities or logical entities, and units with different names may be implemented by a same physical entity.

According to an embodiment of the present disclosure, the position determination unit 910 may determine, in a case where the number of candidate time slots in a resource selection window is less than a predetermined threshold, a position of a time slot to be listened to according to positions of the candidate time slots and a period of periodic partial sensing.

According to an embodiment of the present disclosure, the sensing unit 920 may perform sensing on a channel to determine a free state of resources on the channel. The free state includes but is not limited to free and occupied. Further, the sensing performed by the sensing unit 920 may be full sensing, periodic partial sensing, or continuous partial sensing. For example, the sensing unit 920 may execute the periodic partial sensing to perform listening at the position of the time slot to be listened to, to determine free resources in the candidate time slots.

According to an embodiment of the present disclosure, the resource determination unit 930 may determine resources to be used for sidelink transmission from the free resources in the candidate time slots.

As mentioned above, with the electronic equipment, the wireless communication method and the computer-readable storage medium according to the present disclosure, in a case where the number of candidate time slots is less than the predetermined threshold, the electronic equipment 900 can also determine the position of the time slot to be listened to according to the positions of the candidate time slots, and thereby select resources from the candidate time slots. In this way, the periodic partial sensing can be realized in a case where the number of candidate slots is less than a predetermined threshold.

According to an embodiment of the present disclosure, as shown in FIG. 9, the electronic equipment 900 may further include a communication unit 940 for sending/receiving information. For example, the electronic equipment 900 may receive, from network side equipment via the communication unit 940, the predetermined threshold for the candidate time slots configured by the network side equipment. Here, the network side equipment may be base station equipment serving the electronic equipment 900. The electronic equipment 900 may determine positions and the number of the candidate time slots, and then determine a relationship between the number of the candidate time slots and the predetermined threshold for the candidate time slots.

According to an embodiment of the present disclosure, in a case where the number Y of candidate time slots in a resource selection window is less than a predetermined threshold Yₘᵢₙ, the position determination unit 910 may determine, through a physical layer of the electronic equipment 900, a position of a time slot to be listened to according to positions of the candidate time slots and a period of periodic partial sensing. That is, the physical layer of the electronic equipment 900 may initialize the Y candidate time slots and determine the position of the time slot to be listened to according to positions of the Y candidate time slots and the period of the periodic partial sensing.

Further, the sensing unit 920 may perform listening at the position of the time slot to be listened to through a physical layer of the electronic equipment 900, to determine free resources in the candidate time slots. Further, the physical layer of the electronic equipment 900 may report the free resources in the candidate time slots to an MAC layer of the electronic equipment 900.

Further, the resource determination unit 930 may determine, through the MAC layer of the electronic equipment 900, resources to be used for sidelink transmission from the free resources in the candidate time slots.

According to an embodiment of the present disclosure, while the physical layer of the electronic equipment 900 reports the free resources in the candidate time slots to the MAC layer, the physical layer further send the number Y of the candidate time slots to the MAC layer. In this way, the MAC layer learns that the number Y of the candidate time slots is less than the predetermined threshold Yₘᵢₙ, and therefore determines that the free resources in the candidate time slots selected by the physical layer may be unsatisfactory, and then performs corresponding operations. For example, the MAC layer may improve a reliability of data transmission by increasing the number of data retransmissions or other operations, so as to make up for a shortcoming caused by the unsatisfactory free resources selected by the physical layer.

FIG. 10 is a schematic diagram illustrating a process of determining resources in a case where the number of candidate time slots is less than a predetermined threshold according to a second embodiment of the present disclosure. In FIG. 10, it is assumed that the number Y of candidate time slots determined by the electronic equipment 900 satisfies Y=3, and the predetermined threshold Yₘᵢₙ of the candidate time slots configured by the network side equipment satisfies Yₘᵢₙ=4. That is, the number of candidate time slots is less than the predetermined threshold for the candidate time slots. As shown in FIG. 10, in a case where the number of candidate time slots is less than the predetermined threshold for the candidate time slots, the electronic equipment 900 may determine the position and number of the time slot to be listened to according to the Y candidate time slots, and thereby determine the resources to be used for sidelink transmission.

According to an embodiment of the present disclosure, the position determination unit 910 may further determine one or more extra time slots in the resource selection window so that a sum of the number of the candidate time slots and the number of the extra time slots is greater than or equal to the predetermined threshold. For example, the position determination unit 910 may determine the extra time slots in the resource selection window through a physical layer of the electronic equipment 900.

According to an embodiment of the present disclosure, the sensing unit 920 may determine partial resources in the extra time slots. For example, the physical layer of the electronic equipment 900 may determine the partial resources in the extra time slots. In addition, the physical layer of the electronic equipment 900 may randomly determine the partial resources in the extra time slots, and perform re-evaluation/resource occupancy check on the randomly selected partial resources through the sensing unit 920 to determine whether the randomly selected partial resources are free, so as to user the resources for sidelink transmission when the resources are free. Alternatively, the physical layer of the electronic equipment 900 may perform continuous partial sensing through the sensing unit 920 to determine partial free resources from the extra time slots.

According to an embodiment of the present disclosure, the physical layer of the electronic equipment 900 may send the free resources in the candidate time slots and the partial resources in the extra time slots to an MAC layer.

According to an embodiment of the present disclosure, the resource determination unit 930 may determine the resources to be used for sidelink transmission from the free resources in the candidate time slots and the partial resources in the extra time slots. For example, the MAC layer of the electronic equipment 900 may determine, through the resource determination unit 930, the resources to be used for sidelink transmission from the free resources in the candidate time slots and the partial resources in the extra time slots.

According to an embodiment of the present disclosure, when sending the free resources in the candidate time slots and the partial resources in the extra time slots to the MAC layer, the physical layer of the electronic equipment 900 may further send, to the MAC layer, indication information indicating whether each resource (each resource from the free resources in the candidate time slots and the partial resources in the extra time slots) belongs to the candidate time slots or the extra time slots. In this way, the MAC layer learns which resources are from the candidate time slots and which resources are from the extra time slots. Therefore, a source of the resources can be considered when determining the resources to be used for sidelink transmission. For example, the MAC layer may attempt to select resources from the candidate time slots.

FIG. 11 is a schematic diagram illustrating a process of determining resources in a case where the number of candidate time slots is less than a predetermined threshold according to a second embodiment of the present disclosure. In FIG. 11, it is assumed that the number Y of candidate time slots determined by the electronic equipment 900 satisfies Y=3, and the predetermined threshold Yₘᵢₙ of the candidate time slots configured by the network side equipment satisfies Yₘᵢₙ=4. That is, the number of candidate time slots is less than the predetermined threshold for the candidate time slots. In this case, the electronic equipment 900 selects one extra time slot. As shown in FIG. 11, the electronic equipment 900 may determine the position and number of the time slot to be listened to according to the Y candidate time slots, and thereby determine free resources in the Y candidate time slots. In addition, the electronic equipment 900 may select partial resources in the extra time slot, and thereby determine resources to be used for sidelink transmission from the free resources in the candidate time slots and the partial resources in the extra time slot.

As mentioned above, with the electronic equipment, the wireless communication method and the computer-readable storage medium according to the present disclosure, in a case where the number of candidate time slots is less than the predetermined threshold, the electronic equipment 900 can also determine the position of the time slot to be listened to according to the positions of the candidate time slots, and thereby select resources from the candidate time slots. Further, the electronic equipment 900 may determine extra time slots and select resources from the candidate time slots and the extra time slots. In summary, the periodic partial sensing can be realized in a case where the number of candidate slots is less than a predetermined threshold.

### 4. Exemplary Configuration of Electronic Equipment According to a Third Embodiment

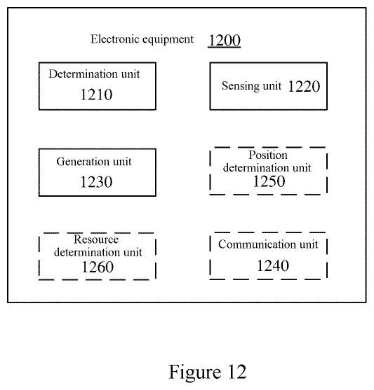

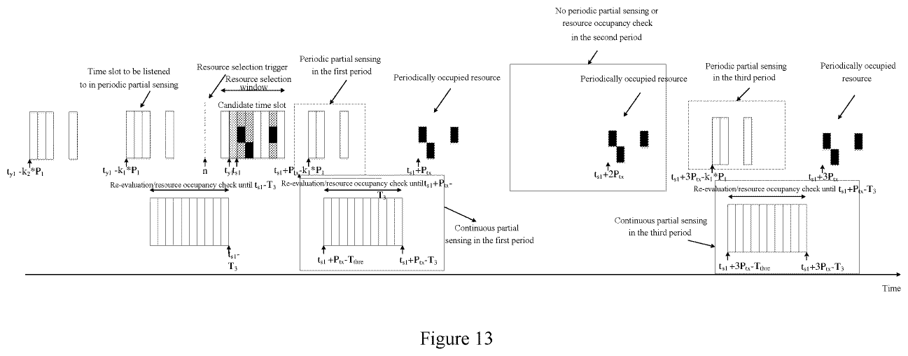

FIG. 12 is a block diagram illustrating a structure of electronic equipment 1200 serving as user equipment in a wireless communication system according to a third embodiment of the present disclosure.

As shown in FIG. 12, the electronic equipment 1200 may include a determination unit 1210, a sensing unit 1220 and a generation unit 1230.

Here, units of the electronic equipment 1200 may be included in processing circuitry. It should be noted that the electronic equipment 1200 may include a single processing circuit or multiple processing circuits. Further, the processing circuitry may include various discrete functional units for performing various different functions and/or operations. It should be noted that these functional units may be physical entities or logical entities, and units with different names may be implemented by a same physical entity.

According to an embodiment of the present disclosure, the electronic equipment 1200 may reuse, in each data transmission period, periodically occupied resources for sidelink transmission. That is, a resource scheduling method of the electronic equipment 1200 is to occupy resources periodically. In the present disclosure, the resources periodically occupied in data transmission periods are the same resources in a frequency domain with the data transmission period as a period in a time domain. That is, the resources periodically occupied in adjacent data transmission periods are the same in the frequency domain and are apart from each other in the time domain by time slots in a quantity equal to the data transmission period. In addition, according to an embodiment of the present disclosure, the electronic equipment 1200 may determine initial resources that are periodically occupied through any of the methods described above. For example, the electronic equipment 1200 may obtain free resources in candidate time slots through periodic partial sensing, so as to determine the initial resources.

According to an embodiment of the present disclosure, the determination unit 1210 may determine whether to perform a resource occupancy check on the periodically occupied resources before using the periodically occupied resources in a data transmission period. In other words, the determination unit 1210 may determine to perform the resource occupancy check on the periodically occupied resources before using the periodically occupied resources in part of the data transmission periods, and perform no resource occupancy check on the periodically occupied resources before using the periodically occupied resources in the other part of the data transmission periods.

According to an embodiment of the present disclosure, the sensing unit 1220 may perform sensing on a channel to determine a free state of resources on the channel. The free state includes but is not limited to free and occupied. Further, the sensing performed by the sensing unit 1220 may be full sensing, periodic partial sensing, or continuous partial sensing.

According to an embodiment of the present disclosure, in the data transmission period in which the periodically occupied resources that need the resource occupancy check determined by the determination unit 1210 are located, before reusing the periodically occupied resources, the sensing unit 1220 may perform execute continuous partial sensing on the periodically occupied resources to determine whether periodically occupied resources are free, thereby realizing the resource occupancy check.

According to an embodiment of the present disclosure, in the data transmission period in which the periodically occupied resources that need no resource occupancy check determined by the determination unit 1210 are located, the electronic equipment 1200 performs no resource occupancy check on the periodically occupied resources. Further, the generation unit 1230 may generate information indicating that the electronic equipment 1200 performs no resource occupancy check on the periodically occupied resources. Alternatively, the generation unit 1230 may generate information indicating a priority of data packets sent by using the periodically occupied resources, where the electronic equipment 1200 may increase a priority of data packets sent by reusing the periodically occupied resources.

As described above, with the electronic equipment, the wireless communication method and the computer-readable storage medium according to the present disclosure, in a case where the electronic equipment 1200 uses the resources in a manner of periodically occupying the resources, the electronic equipment 1200 can perform resource occupancy check on the resources before reusing the periodically occupied resources in part of the data transmission period, and perform no resource occupancy check on the resources before reusing the periodically occupied resources in the other part of the data transmission periods. In the case of no resource occupancy check, the electronic equipment 1200 may generate information indicating that the electronic equipment performs no resource occupancy check on the periodically occupied resources, or increase a priority of data packets. In this way, other user equipment learns that the electronic equipment 1200 uses the periodically occupied resources without the resource occupancy check, and therefore avoids using the resources as much as possible; or in a case of resource collision, other user equipment may perform resource re-selection due to the higher priority of the data packets. In summary, the probability of resource collision between the electronic equipment 1200 and other user equipment can be reduced.

According to an embodiment of the present disclosure, in the data transmission period in which the periodically occupied resources that need the resource occupancy check determined by the determination unit 1210 are located, before reusing the periodically occupied resources, the sensing unit 1220 may further perform periodic partial sensing on the periodically occupied resources to determine whether periodically occupied resources are free, and determine whether the periodically occupied resources are free according to a result of the resource occupancy check and a result of the periodic partial sensing.

According to an embodiment of the present disclosure, in the data transmission period in which the periodically occupied resources that need no resource occupancy check determined by the determination unit 1210 are located, the electronic equipment 1200 may perform no periodic partial sensing on the periodically occupied resources. That is, the electronic equipment 1200 directly uses the periodically occupied resources, without the resource occupancy check on the periodically occupied resources or the periodic partial sensing on the periodically occupied resources.

According to an embodiment of the present disclosure, as shown in FIG. 12, the electronic equipment 1200 may further include a position determination unit 1250. The position determination unit 1250 is for determining a position of a time slot to be listened to in the periodic partial sensing. Specifically, the position determination unit 1250 may determine a position of a time slot to be listened to during the periodic partial sensing according to positions of time slots of the periodically occupied resources in the data transmission period.

According to an embodiment of the present disclosure, the position determination unit 1250 may determine a position of a time slot to be listened to according to the position of the time slot of the periodically occupied resources in the data transmission period, a period P′, a position indication K′.

According to an embodiment of the present disclosure, the position determination unit 1250 may use, for each time slot of the periodically occupied resources, a time slot before the time slot and at a distance from the time slot being a third predetermined number of time slots, as the predetermined time slot to be listened to, the third predetermined number being a result obtained by multiplying the period P′ by the position indication K′. Further, in the case where the period P′ and/or the position indication K′ includes multiple elements, the third predetermined number is a result obtained by multiplying each element in the period P′ by each element in the position indication K′. That is, for each time slot of the periodically occupied resources, the position determination unit 1250 may determine multiple time slots to be listened to.

According to an embodiment of the present disclosure, the electronic equipment 1200 may determine each element within the period P′. For example, the electronic equipment 1200 may set the period P′ as a subset of a period P configured by the network side equipment. Alternatively, the electronic equipment 1200 may determine a period from other periods which are supported by the resource pool and are not included in the period P as the period P′, which is not limited in the present disclosure. Similarly, the electronic equipment 1200 may determine each element in the position indication K′. For example, the electronic equipment 1200 may set the position indication K′ as a subset of a position indication K configured by the network side equipment. Alternatively, the electronic equipment 1200 may determine a value from other values not included in the K as the K′, which is not limited in the present disclosure.

As described above, according to embodiments of the present disclosure, the position of the time slot to be listened to during the periodic partial sensing can be determined according to the position of the time slot of the periodically occupied resources in the data transmission period, rather than according to the positions of the candidate time slots when determining the initial resources. Thus, the time slot to be listened to during the periodic partial sensing performed when reusing the periodically occupied resources may be different from the time slot to be listened to during the periodic partial sensing performed when determining the initial resources to be periodically occupied. Thereby, the number of time slots to be listened to is reduced.

As described above, in a case where the resource occupancy check and the periodic partial sensing are performed on the periodically occupied resources in part of the data transmission periods, and the resource occupancy check or the periodic partial sensing is not performed on the periodically occupied resources in the other part of the data transmission periods, the position of the time slot to be listened to during the periodic partial sensing may be determined according to the position of the time slot of the periodically occupied resources in the data transmission period. The present disclosure is not limited thereto. In a case where the resource occupancy check and the periodic partial sensing are performed on the periodically occupied resources in the entire data transmission period, the position of the time slot to be listened to during the periodic partial sensing may also be determined according to the position of the time slot of the periodically occupied resources in the data transmission period. In other words, according to an embodiment of the present disclosure, the electronic equipment may include processing circuitry, configured to: reuse, in each data transmission period, periodically occupied resources for sidelink transmission; and perform, before reusing the periodically occupied resources in each data transmission period, a resource occupancy check and periodic partial sensing on the periodically occupied resources to determine whether the periodically occupied resources are free. Further, the processing circuitry is further configured to: determine a position of a time slot to be listened to during the periodic partial sensing according to a position of a time slot of the periodically occupied resources in the data transmission period.

According to an embodiment of the present disclosure, in the resource occupancy check, the sensing unit 1220 may determine a distance between a start time of the resource occupancy check and a time of reusing the periodically occupied resources as being greater than or equal to a predetermined threshold Tₜₕᵣₑ. In other words, for a periodically occupied resource, the sensing unit 1220 may perform the resource occupancy check, where a distance between a start time of the resource occupancy check and the periodically occupied resource is greater than or equal to Tₜₕᵣₑ. Further, the distance between an end time of the resource occupancy check and the periodically occupied resource is T₃, where T₃ is a constant parameter configured by the network side equipment. Assuming that the time slot in which the periodically occupied resources are located is tₛ, then the electronic equipment 1200 may perform the resource occupancy check on the periodically occupied resources to sense whether resources on time slots from tₛ−Tₜₕᵣₑ to tₛ−T₃ are free.

FIG. 13 is a schematic diagram illustrating a process of sensing in a case of periodically occupied resources according to a third embodiment of the present disclosure. As shown in FIG. 13, the electronic equipment 1200 determines initial resources for periodic occupancy in the candidate time slots according to a listening result of the periodic part sensing. In a first period after the initial resources (referred to as a first period for short), periodic partial sensing and resource occupancy check (implemented through continuous partial sensing) are performed on the periodically occupied resources in the period. In a case of periodic partial sensing, assuming that four candidate time slots are numbered 1 to 4 from left to right, the initial resources periodically occupied are at the time slots number 2, 3, and 4. Therefore, the time slots sensed in the periodic partial sensing are determined to be positions corresponding to the three candidate time slots. That is, for a candidate time slot tₛ₁, a time domain position of the periodically occupied resources in the first period is tₛ₁+Pₜₓ, where Pₜₓ represents the data transmission period of the electronic equipment 1200, and then the time slot needed to be sensed is tₛ₁+Pₜₓ−k₁×P₁. Here, although it is shown that the position of the time slot during the periodic partial sensing in the first period is determined according to k₁ and P₁, the present disclosure is not limited thereto. That is, in the first period, positions of multiple time slots needed to be sensed may be determined according to the time slots of the periodically occupied resources. In addition, values of K and P are not limited to those configured by the network side equipment. In the case of continuous partial sensing, for a the periodically occupied resource, the electronic equipment 1200 may perform continuous partial sensing to re-evaluate a free state of the resource, until a time instant T₃ before the resource. In addition, a distance between a start position of the continuous partial sensing and the resource is Tₜₕᵣₑ. In a second period after the initial resources (referred to as a second period for short), no periodic partial sensing or continuous partial sensing is performed on the periodically occupied resources in the period, and the periodically occupied resources in this period are used directly. In a third period after the initial resources (referred to as a third period for short), the periodic partial sensing and continuous partial sensing are performed on the periodically occupied resources in this period. A process of the periodic partial sensing and continuous partial sensing in the third period is similar to the process of the periodic partial sensing and continuous partial sensing in the first period, and is not repeated here.

According to an embodiment of the present disclosure, as shown in FIG. 12, the electronic equipment 1200 may further include a resource determination unit 1260. The resource determination unit 1260 is for determining or re-selecting resources to be used for sidelink transmission.

According to an embodiment of the present disclosure, in the case where both the resource occupancy check and the periodic partial sensing are performed, the physical layer of the electronic equipment 1200 may determine whether a resource is free according to a result of the resource occupancy check and a result of the periodic partial sensing. For example, in a case where one or both results of the resource occupancy check and the periodic partial sensing indicate that the resources are occupied, the physical layer of the electronic equipment 1200 may determine that the resource is occupied. Alternatively, the electronic equipment 1200 may combine the result of the resource occupancy check and the result of the periodic partial sensing in any manner, and determine whether the resource is free based on a result of the combination.

According to an embodiment of the present disclosure, on determining that the periodically occupied resources are free, the physical layer may use the periodically occupied resources; and on determining that the periodically occupied resources are not free, the physical layer may report to the MAC layer, so that the MAC layer triggers resource re-selection, that is, the MAC layer may re-select the resources to be used for sidelink transmission through the resource determination unit 1260.

According to an embodiment of the present disclosure, for a data transmission period requiring no resource occupancy check determined by the determination unit 1210, the generation unit 1230 may generate information indicating a priority of data packets sent by using the periodically occupied resources, where the electronic equipment 1200 may increase a priority of data packets sent by reusing the periodically occupied resources. Here, the electronic equipment 1200 may increase the priority of the data packets to a predetermined level, or the electronic equipment 1200 may increase the priority of the data packets by a predetermined number of levels.

According to an embodiment of the present disclosure, as shown in FIG. 12, the electronic equipment 1200 may further include a communication unit 1240 for sending/receiving information.

According to an embodiment of the present disclosure, the electronic equipment 1200 may send the information generated by the generation unit 1230 through the communication unit 1240. Specifically, the electronic equipment 1200 may carry the information through SCI (Sidelink Control Information). For example, the information is sent through SCI during the data transmission period requiring no resource occupancy check.

According to an embodiment of the present disclosure, for a period requiring no resource occupancy check determined by the determination unit 1210, the generation unit 1230 may further generate information indicating that the electronic equipment 1200 performs no periodic partial sensing on the periodically occupied resources. Further, the electronic equipment 1200 may carry the information through the SCI and send the information through the communication unit 1240. Specifically, the electronic equipment 1200 may carry the information through SCI within and/or before the period.

According to an embodiment of the present disclosure, the electronic equipment 1200 may broadcast the SCI information. In this way, not only the user equipment serving as a receiver can receive the SCI information, other user equipment can also receive the SCI information. In a case where the SCI information includes an increased priority, other user equipment may perform resource re-selection in response to a resource collision, as this resource has a higher priority. In a case where the SCI information includes information indicating that the electronic equipment 1200 performs no resource occupancy check on the resource, other user equipment may avoid using the resource. In short, the probability of resource collision between other user equipment and the electronic equipment 1200 can be reduced.

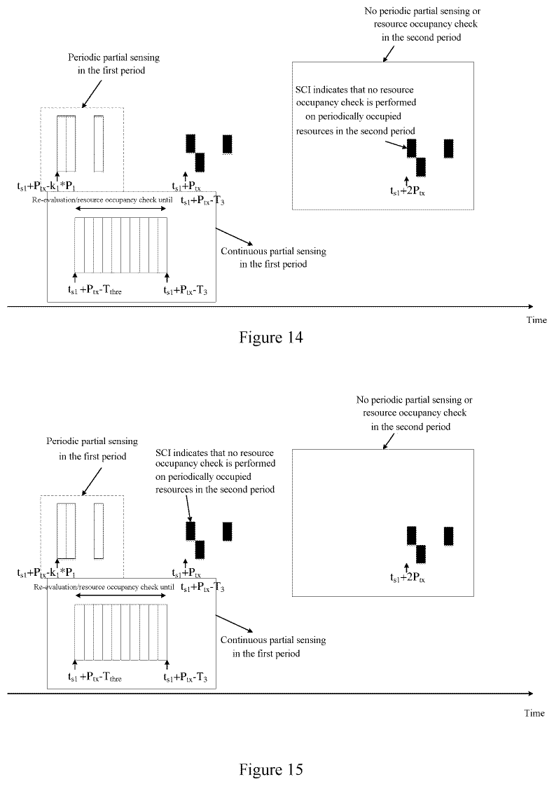

FIG. 14 is a schematic diagram illustrating a process of indicating resources on which no resource occupancy check is performed in a case of periodically occupied resources according to a third embodiment of the present disclosure. In FIG. 14, for convenience of illustration, only the first period and the second period in FIG. 13 are shown. As shown in FIG. 14, no resource occupancy check is performed on the periodically occupied resources in the second period. Therefore, SCI carried on a first selected resource in the second period is for indicating that the electronic equipment 1200 performs no resource occupancy check on the periodically occupied resources in this period.

FIG. 15 is a schematic diagram illustrating a process of indicating resources on which no resource occupancy check is performed in a case of periodically occupied resources according to a third embodiment of the present disclosure. In FIG. 15, for convenience of illustration, only the first period and the second period in FIG. 13 are shown. As shown in FIG. 15, no resource occupancy check is performed on the periodically occupied resources in the second period. Therefore, SCI carried on a first selected resource in the first period is for indicating that the electronic equipment 1200 performs no resource occupancy check on the periodically occupied resources in a next period. In this way, notification can be provided in advance to avoid late reaction to the information by other user equipment. In addition, in order to further improve the reliability of information transmission, the electronic equipment 1200 may further indicate that the electronic equipment 1200 performs no resource occupancy check on the periodically occupied resources in the next period by using the SCI carried on the first selected resource in the first period and the SCI carried on the first selected resource in the second period.

### 5. Method Embodiment

Next, a wireless communication method performed by the electronic equipment 500 serving as user equipment in a wireless communication system according to the first embodiment of the present disclosure is described in detail.

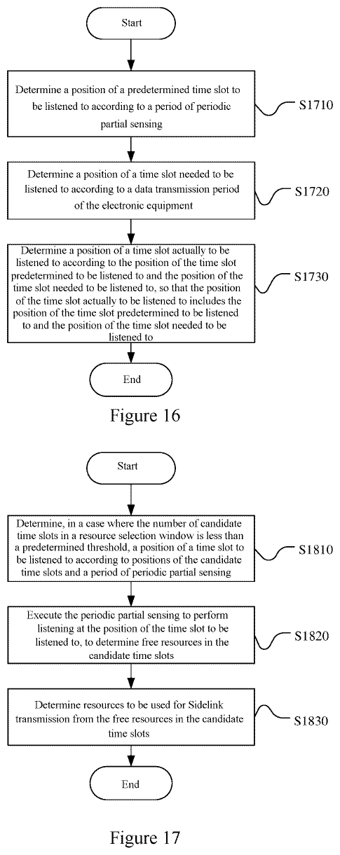

FIG. 16 is a flowchart illustrating a wireless communication method performed by the electronic equipment 500 serving as user equipment in a wireless communication system according to the first embodiment of the present disclosure.

Reference is made to FIG. 16. In step S1710, a position of a predetermined time slot to be listened to is determined according to a period of periodic partial sensing.

In step S1720, a position of a time slot needed to be listened to is determined according to a data transmission period of the electronic equipment 500.

In step S1730, a position of a time slot actually to be listened to is determined according to the position of the predetermined time slot to be listened to and the position of the time slot needed to be listened to, so that the position of the time slot actually to be listened to includes the position of the predetermined time slot to be listened to and the position of the time slot needed to be listened to.

Preferably, the wireless communication method further includes: receiving, from network side equipment, a period of the periodic partial sensing and a position indication of the periodic partial sensing which are configured by the network side equipment; and determining the position of the predetermined time slot to be listened to according to the period of the periodic partial sensing and the position indication of the periodic partial sensing.

Preferably, the wireless communication method further includes: determining one or more candidate time slots in a resource selection window; and using, for each candidate time slot, a time slot before the candidate time slot and at a distance from the candidate time slot of a first predetermined number of time slots, as the predetermined time slot to be listened to, the first predetermined number being a result obtained by multiplying the period of the periodic partial sensing by the position indication of the periodic partial sensing.

Preferably, the wireless communication method further includes: determining the position of the time slot needed to be listened to according to the data transmission period of the electronic equipment 500 and the position indication of the periodic partial sensing.

Preferably, the wireless communication method further includes: determining one or more candidate time slots in a resource selection window; and using, for each candidate time slot, a time slot before the candidate time slot and at a distance from the candidate time slot of a second predetermined number of time slots, as the time slot needed to be listened to, the second predetermined number being a result obtained by multiplying the data transmission period of the electronic equipment 500 by the position indication of the periodic partial sensing.

Preferable, the period of the periodic partial sensing includes one or more periods selected from periods supported by a resource pool, and the position indication of the periodic partial sensing includes one or more position indications.

Preferable, the wireless communication method further includes: executing the periodic partial sensing to perform listening at the position of the time slot actually to be listened to, to use free resources for sidelink transmission.

According to an embodiment of the present disclosure, a subject that performs the method may be the electronic equipment 500 according to the embodiment of the present disclosure. Therefore, the previous embodiments of the electronic equipment 500 are applicable here.

Next, a wireless communication method performed by the electronic equipment 900 serving as user equipment in a wireless communication system according to the second embodiment of the present disclosure is described in detail.

FIG. 17 is a flowchart illustrating a wireless communication method performed by the electronic equipment 900 serving as user equipment in a wireless communication system according to the second embodiment of the present disclosure.

Reference is made to FIG. 17. In step S1810, in a case where the number of candidate time slots in a resource selection window is less than a predetermined threshold, a position of a time slot to be listened to is determined according to positions of the candidate time slots and a period of periodic partial sensing.

In step S1820, the periodic partial sensing is executed to perform listening at the position of the time slot to be listened to, to determine free resources in the candidate time slots.

In step S1830, resources to be used for sidelink transmission are determined from the free resources in the candidate time slots.

Preferably, the wireless communication method further includes: performing listening at the position of the time slot to be listened to through a physical layer, to determine free resources in the candidate time slots; sending the free resources in the candidate time slots to an MAC layer through the physical layer; and determining, through the MAC layer, the resources to be used for sidelink transmission from the free resources in the candidate time slots.

Preferably, the wireless communication method further includes: sending the number of the candidate time slots to the MAC layer through the physical layer.

Preferably, the wireless communication method further includes: determining one or more extra time slots in the resource selection window so that a sum of the number of the candidate time slots and the number of the extra time slots is greater than or equal to the predetermined threshold; determining partial resources in the extra time slots; and determining resources to be used for sidelink transmission from the free resources in the candidate time slots and the partial resources in the extra time slots.

Preferably, the wireless communication method further includes: determining the extra time slots in the resource selection window through a physical layer; sending the free resources in the candidate time slots and the partial resources in the extra time slots to an MAC layer through the physical layer; and determining, through the MAC layer, the resources to be used for sidelink transmission from the free resources in the candidate time slots and the partial resources in the extra time slots.

Preferably, the wireless communication method further includes: sending indication information indicating whether each resource belongs to the candidate time slots or the extra time slots to the MAC layer through the physical layer.

According to an embodiment of the present disclosure, a subject that performs the method may be the electronic equipment 900 according to the embodiment of the present disclosure. Therefore, the previous embodiments of the electronic equipment 900 are applicable here.

Next, a wireless communication method performed by the electronic equipment 1200 serving as user equipment in a wireless communication system according to the third embodiment of the present disclosure is described in detail.

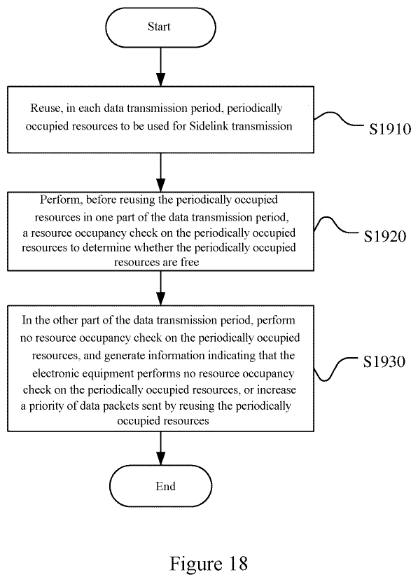

FIG. 18 is a flowchart illustrating a wireless communication method performed by the electronic equipment 1200 serving as user equipment in a wireless communication system according to the third embodiment of the present disclosure.

Reference is made to FIG. 18. In step S1910, in each data transmission period, periodically occupied resources are reused for sidelink transmission.

In step S1920, before reusing the periodically occupied resources in part of the data transmission periods, a resource occupancy check is performed on the periodically occupied resources to determine whether the periodically occupied resources are free.

In step S1930, in the other part of the data transmission periods, no resource occupancy check is performed on the periodically occupied resources, and information indicating that the electronic equipment performs no resource occupancy check on the periodically occupied resources is generated, or a priority of data packets sent by reusing the periodically occupied resources is increased.

Preferably, the wireless communication method further includes: performing, before reusing the periodically occupied resources in the part of the data transmission periods, periodic partial sensing on the periodically occupied resources, and determining whether the periodically occupied resources are free based on a result of the resource occupancy check and a result of the periodic partial sensing.

Preferably, the wireless communication method further includes: determining a position of a time slot to be listened to during the periodic partial sensing according to positions of time slots of the periodically occupied resources in the data transmission period.

Preferably, the wireless communication method further includes: in the resource occupancy check, making a distance between a start time of the resource occupancy check and a time of reusing the periodically occupied resources greater than or equal to a predetermined threshold.

Preferably, the wireless communication method further includes: performing resource re-selection in a case where it is determined that the periodically occupied resources are not free.

Preferably, the wireless communication method further includes: sending the information via sidelink control information SCI, in each data transmission period in the other part of the data transmission periods and/or in a data transmission period before each data transmission period in the other part of the data transmission periods.

According to an embodiment of the present disclosure, a subject that performs the method may be the electronic equipment 1200 according to the embodiment of the present disclosure. Therefore, the previous embodiments of the electronic equipment 1200 are applicable here.

As described above, the first to third embodiments according to the present disclosure are described in an independent manner. However, the first to third embodiments of the present disclosure may be compatible to each other. That is, although the electronic equipment 500, the electronic equipment 900 and the electronic equipment 1200 are described through FIG. 5, FIG. 9 and FIG. 12, respectively, the electronic equipment may have structures and functions in two or three of the figures. For units having a repeated function, the electronic equipment may have only one of the units.

For example, in a case that electronic equipment has the functions of the electronic equipment 500 in FIG. 5 and functions of the electronic equipment 900 in FIG. 9, the electronic equipment may have the first determination unit 510, the second determination unit 520, the third determination unit 530, the candidate time slot determination unit 550, the resource determination unit 930, the sensing unit 560 and the communication unit 540. The position determination unit 910 may have the same function as the third determination unit 530, the sensing unit 920 may have the same function as the sensing unit 560, and the communication unit 940 may have the same function as the communication unit 540. That is, in a case where the number of candidate time slots in the resource selection window is less than a predetermined threshold, the position determination unit 910 may determine the position of the time slot actually to be listened to in a similar manner to the third determination unit 530, and therefore the sensing unit 920 performs listening to the time slot actually to be listened to, and the resource determination unit 930 determines the resources to be used for sidelink transmission.

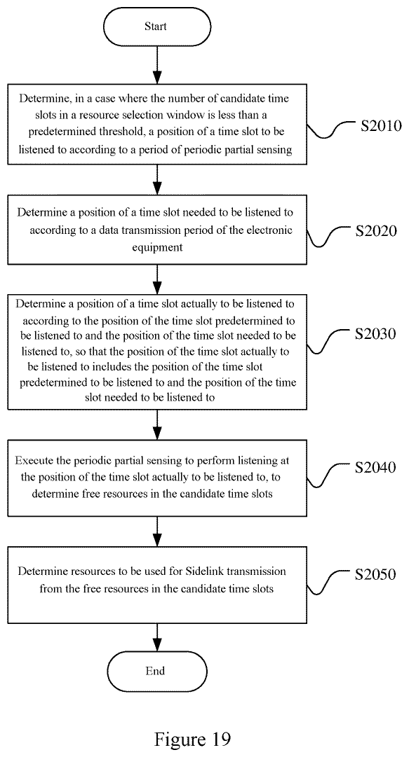

FIG. 19 is a flowchart illustrating a wireless communication method performed by electronic equipment according to an embodiment of the present disclosure. Reference is made to FIG. 19. In step S2010, in a case where the number of candidate time slots in a resource selection window is less than a predetermined threshold, a position of a predetermined time slot to be listened to is determined according to a period of periodic partial sensing. In step S2020, a position of a time slot needed to be listened to is determined according to a data transmission period of the electronic equipment. In step S2030, a position of a time slot actually to be listened to is determined according to the position of the predetermined time slot to be listened to and the position of the time slot needed to be listened to, so that the position of the time slot actually to be listened to includes the position of the predetermined time slot to be listened to and the position of the time slot needed to be listened to. In step S2040, the periodic partial sensing is executed by the electronic equipment to perform listening at the position of the time slot actually to be listened to, to determine free resources in the candidate time slots. In step S2050, resources to be used for sidelink transmission are determined from the free resources in the candidate time slots. In addition, the previous embodiments about the electronic equipment 500 and the electronic equipment 900 are applicable here.

For example, in a case that electronic equipment has the functions of the electronic equipment 500 in FIG. 5 and functions of the electronic equipment 1200 in FIG. 12, the electronic equipment may have the first determination unit 510, the second determination unit 520, the third determination unit 530, the candidate time slot determination unit 550, the sensing unit 560 and the communication unit 540, the determination unit 1210, the generation unit 1230, the position determination unit 1250 and the resource determination unit 1260. The sensing unit 1220 may have the same function as the sensing unit 560, and the communication unit 1240 may have the same function as the communication unit 540. That is, in a case where the electronic equipment adopts a resource scheduling method of periodically occupying resources, the electronic equipment may determine the initial resources that are periodically occupied according to the method in the first embodiment, and then determine reuse of the periodically occupied resources according to the method in the third embodiment.

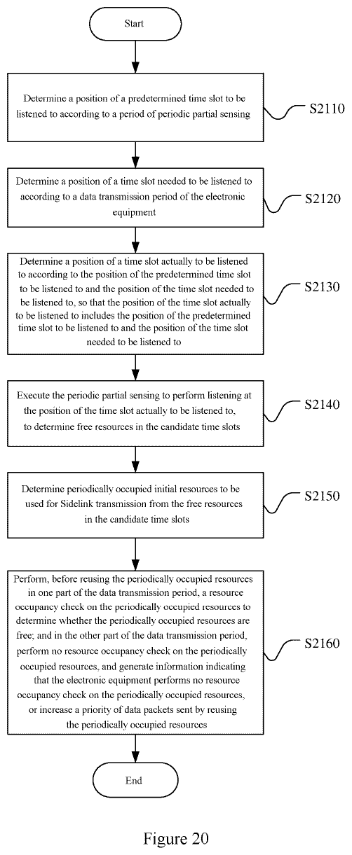

FIG. 20 is a flowchart illustrating a wireless communication method performed by electronic equipment according to an embodiment of the present disclosure. Reference is made to FIG. 20. In step S2110, a position of a predetermined time slot to be listened to is determined according to a period of periodic partial sensing. In step S2120, a position of a time slot needed to be listened to is determined according to a data transmission period of the electronic equipment. In step S2130, a position of a time slot actually to be listened to is determined according to the position of the predetermined time slot to be listened to and the position of the time slot needed to be listened to, so that the position of the time slot actually to be listened to includes the position of the predetermined time slot to be listened to and the position of the time slot needed to be listened to. In step S2140, the periodic partial sensing is executed to perform listening at the position of the time slot actually to be listened to, to determine free resources in the candidate time slots. In step S2150, periodically occupied initial resources to be used for sidelink transmission are determined from the free resources in the candidate time slots. In step S2160, before reusing the periodically occupied resources in part of the data transmission periods, a resource occupancy check is performed on the periodically occupied resources to determine whether the periodically occupied resources are free; and before reusing the periodically occupied resources in the other part of the data transmission periods, no resource occupancy check is performed on the periodically occupied resources, and information indicating that the electronic equipment performs no resource occupancy check on the periodically occupied resources is generated, or a priority of data packets sent by reusing the periodically occupied resources is increased. In addition, the previous embodiments about the electronic equipment 500 and the electronic equipment 1200 are applicable here.

For example, in a case that electronic equipment has the functions of the electronic equipment 900 in FIG. 9 and functions of the electronic equipment 1200 in FIG. 12, the electronic equipment may have the position determination unit 910, the sensing unit 920, the resource determination unit 930, the communication unit 940, the determination unit 1210 and the generation unit 1230. The sensing unit 1220 may have the same function as the sensing unit 920, the communication unit 1240 may have the same function as the communication unit 940, the position determination unit 1250 may have the same function as the position determination unit 910, and the resource determination unit 1260 may have the same function as the resource determination unit 930. That is, in a case where the electronic equipment adopts a resource scheduling method of periodically occupying resources and the number of candidate time slots is less than a predetermined threshold, the electronic equipment may determine the initial resources that are periodically occupied according to the method in the second embodiment, and then determine reuse of the periodically occupied resources according to the method in the third embodiment.

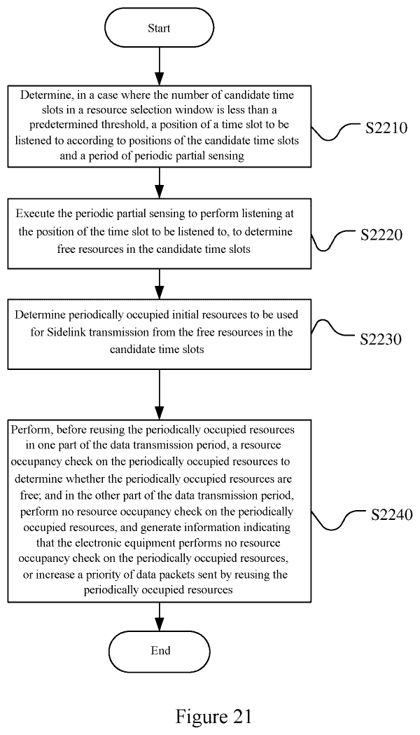

FIG. 21 is a flowchart illustrating a wireless communication method performed by electronic equipment according to an embodiment of the present disclosure. Reference is made to FIG. 21. In step S2210, in a case where the number of candidate time slots in a resource selection window is less than a predetermined threshold, a position of a time slot to be listened to is determined according to positions of the candidate time slots and a period of periodic partial sensing. In step S2220, the periodic partial sensing is executed to perform listening at the position of the time slot to be listened to, to determine free resources in the candidate time slots. In step S2230, periodically occupied initial resources to be used for sidelink transmission are determined from the free resources in the candidate time slots. In step S2240, before reusing the periodically occupied resources in part of the data transmission period, a resource occupancy check is performed on the periodically occupied resources to determine whether the periodically occupied resources are free; and before reusing the periodically occupied resources in the other part of the data transmission periods, no resource occupancy check is performed on the periodically occupied resources, and information indicating that the electronic equipment performs no resource occupancy check on the periodically occupied resources is generated, or a priority of data packets sent by reusing the periodically occupied resources is increased. In addition, the previous embodiments about the electronic equipment 900 and the electronic equipment 1200 are applicable here.

Apparently, the electronic equipment may have all the functions and structures of the electronic equipment 500, the electronic equipment 900, and the electronic equipment 1200. The foregoing embodiments of the electronic equipment 500, the electronic equipment 900, and the electronic equipment 1200 are applicable here.

### 6. Application Example

The technology of the present disclosure is applicable to various products.

For example, the network side equipment may be implemented as base station equipment in any type, such as a macro eNB and a small eNB, or may be implemented as a gNB (a base station in a 5G system) in any type. The small eNB may be an eNB covering a cell smaller than a macro cell, such as a pico eNB, a micro eNB, or a home (femto) eNB. Alternatively, the base station may be implemented as any other type of base station, such as a NodeB or a base transceiver station (BTS). The base station may include a body (which is also referred to as base station equipment) configured to control wireless communication and one or more remote radio heads (RRHs) that are arranged in a different place from the body.

The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a vehicle navigation device). The user equipment may also be implemented as a terminal that performs machine-to-machine (M2M) communication (which is also referred to as a machine type communication (MTC) terminal). Furthermore, the user equipment may be a wireless communication module (such as an integrated circuit module including a single wafer) installed on each user equipment described above.

### [Application Examples of Terminal Equipment]

### First Application Example

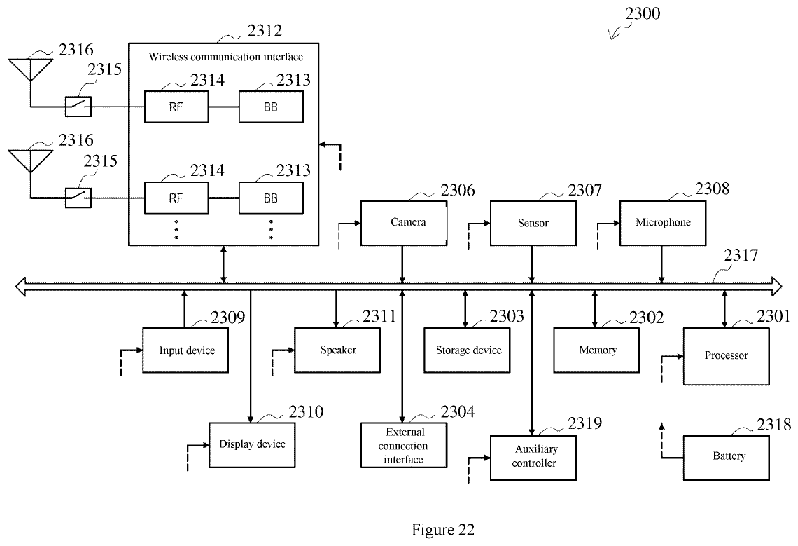

FIG. 22 is a block diagram showing an example of a schematic configuration of a smartphone 2300 to which the technology of the present disclosure may be applied. The smartphone 2300 includes a processor 2301, a memory 2302, a storage device 2303, an external connection interface 2304, a camera device 2306, a sensor 2307, a microphone 2308, an input device 2309, a display device 2310, a speaker 2311, a wireless communication interface 2312, one or more antenna switches 2315, one or more antennas 2316, a bus 2317, a battery 2318, and an auxiliary controller 2319.

The processor 2301 may be, for example, a CPU or a system on a chip (SoC), and controls the functions of the application layer and other layers of the smartphone 2300. The memory 2302 includes a RAM and a ROM, and stores data and programs executed by the processor 2301. The storage device 2303 may include a storage medium such as a semiconductor memory and a hard disk. The external connection interface 2304 is an interface for connecting an external device, such as a memory card or a universal serial bus (USB) device, to the smartphone 2300.

The camera device 2306 includes an image sensor (such as a charge coupled device (CCD) and a complementary metal oxide semiconductor (CMOS)), and generates a captured image. The sensor 2307 may include a group of sensors, such as a measurement sensor, a gyroscope sensor, a geomagnetic sensor, and an acceleration sensor. The microphone 2308 converts sound inputted to the smartphone 2300 into an audio signal. The input device 2309 includes, for example, a touch sensor configured to detect a touch on a screen of the display device 2310, a keypad, a keyboard, a button, or a switch, and receives an operation or information inputted from a user. The display device 2310 includes a screen, such as a liquid crystal display (LCD) or an organic light emitting diode (OLED) display, and displays an output image of the smartphone 2300. The speaker 2311 converts the audio signal outputted from the smartphone 2300 into sound.

The wireless communication interface 2312 supports any cellular communication scheme (such as LTE and LTE-Advanced), and performs wireless communication. The wireless communication interface 2312 may generally include, for example, a BB processor 2313 and an RF circuit 2314. The BB processor 2313 may perform, for example, encoding/decoding, modulation/demodulation, and multiplexing/demultiplexing, and perform various types of signal processing for wireless communication. Further, the RF circuit 2314 may include, for example, a mixer, a filter, and an amplifier, and transmit and receive wireless signals via the antenna 2316. The wireless communication interface 2312 may be a chip module on which a BB processor 2313 and an RF circuit 2314 are integrated. As shown in FIG. 22, the wireless communication interface 2312 may include multiple BB processors 2313 and multiple RF circuits 2314. Although FIG. 22 shows an example in which the wireless communication interface 2312 includes multiple BB processors 2313 and multiple RF circuits 2314, the wireless communication interface 2312 may include a single BB processor 2313 or a single RF circuit 2314.

In addition to the cellular communication scheme, the wireless communication interface 2312 may support another type of wireless communication scheme, such as a short-range wireless communication scheme, a near field communication scheme, and a wireless local area network (LAN) scheme. In this case, the wireless communication interface 2312 may include a BB processor 2313 and an RF circuit 2314 for each wireless communication scheme.

Each of the antenna switches 2315 switches a connection destination of the antenna 2316 among multiple circuits (for example, circuits for different wireless communication schemes) included in the wireless communication interface 2312.

Each of the antennas 2316 includes a single or multiple antenna elements (such as multiple antenna elements included in a MIMO antenna), and is used for the wireless communication interface 2312 to transmit and receive wireless signals. As shown in FIG. 22, the smartphone 2300 may include multiple antennas 2316. Although FIG. 22 shows an example in which the smartphone 2300 includes multiple antennas 2316, the smartphone 2300 may include a single antenna 2316.

In addition, the smartphone 2300 may include antenna(s) 2316 for each wireless communication scheme. In this case, the antenna switches 2315 may be omitted from the configuration of the smart phone 2300.

The processor 2301, the memory 2302, the storage device 2303, the external connection interface 2304, the camera device 2306, the sensor 2307, the microphone 2308, the input device 2309, the display device 2310, the speaker 2311, the wireless communication interface 2312, and the auxiliary controller 2319 are connected to each other via the bus 2317. The battery 2318 supplies power to each block of the smartphone 2300 shown in FIG. 22 via a feeder line. The feeder line is partially shown as a dashed line in the figure. The auxiliary controller 2319 operates the minimum necessary functions of the smartphone 2300 in a sleep mode, for example.

In the smartphone 2300 shown in FIG. 22, the first determination unit 510, the second determination unit 520, the third determination unit 530, the candidate time slot determination unit 550 and the sensing unit 560 described by using FIG. 5, the position determination unit 910, the sensing unit 920 and the resource determination unit 930 described by using FIG. 9, and the determination unit 1210, the sensing unit 1220, the generation unit 1230, the position determination unit 1250 and the resource determination unit 1260 described by using FIG. 12 may be implemented through the processor 2301 or the auxiliary controller 2319. At least part of the functions may be implemented by the processor 2301 or the auxiliary controller 2319. For example, the processor 2301 or the auxiliary controller 2319 may perform, by executing instructions stored in the memory 2302 or the storage device 2303, the functions of determining the position of the predetermined time slot to be listened to, determining the position of the time slot needed to be listened to, determining the position of the time slot actually to be listened to, determining the candidate time slots, sensing the time slots, determining the resources used for sidelink transmission, determining which periods needs the resource occupancy check, and generating the information indicating that no resource occupancy check is performed on the periodically occupied resources or information including priority of the resources.

### Second Application Example

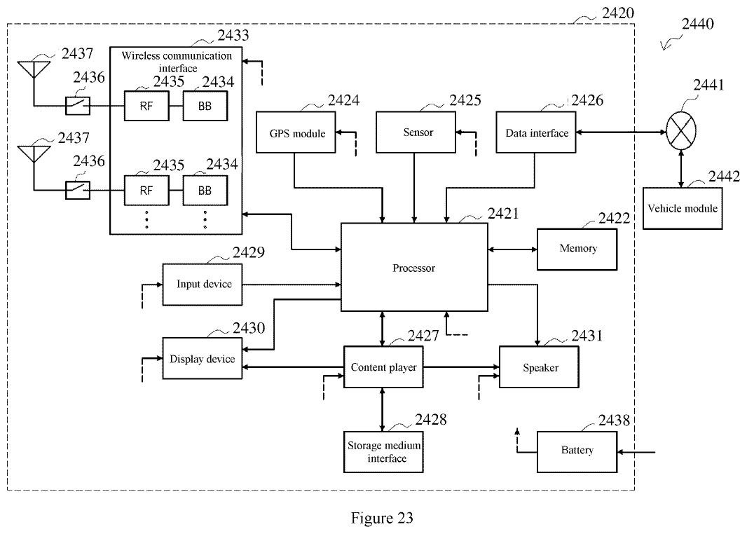

FIG. 23 is a block diagram showing an example of a schematic configuration of a vehicle navigation device 2420 to which the technology of the present disclosure may be applied. The vehicle navigation device 2420 includes a processor 2421, a memory 2422, a global positioning system (GPS) module 2424, a sensor 2425, a data interface 2426, a content player 2427, a storage medium interface 2428, an input device 2429, a display device 2430, a speaker 2431, a wireless communication interface 2433, one or more antenna switches 2436, one or more antennas 2437, and a battery 2438.

The processor 2421 may be, for example, a CPU or SoC, and controls the navigation function of the vehicle navigation device 2420 and other functions. The memory 2422 includes a RAM and a ROM, and stores data and programs executed by the processor 2421.

The GPS module 2424 measures a position (such as latitude, longitude, and altitude) of the vehicle navigation device 2420 based on GPS signals received from GPS satellites. The sensor 2425 may include a group of sensors, such as a gyroscope sensor, a geomagnetic sensor, and an air pressure sensor. The data interface 2426 is connected to, for example, a vehicle-mounted network 2441 via a terminal not shown, and acquires data (such as vehicle speed data) generated by the vehicle.

The content player 2427 reproduces content stored in a storage medium (such as CD and DVD) inserted into the storage medium interface 2428. The input device 2429 includes, for example, a touch sensor configured to detect a touch on a screen of the display device 2430, a button, or a switch, and receives an operation or information inputted from the user. The display device 2430 includes a screen such as an LCD or OLED display, and displays an image of a navigation function or reproduced content. The speaker 2431 outputs a sound of the navigation function or the reproduced content.

The wireless communication interface 2433 supports any cellular communication scheme (such as LTE and LTE-Advanced), and performs wireless communication. The wireless communication interface 2433 may generally include, for example, a BB processor 2434 and an RF circuit 2435. The BB processor 2434 may perform, for example, encoding/decoding, modulation/demodulation, and multiplexing/demultiplexing, and perform various types of signal processing for wireless communication. Further, the RF circuit 2435 may include, for example, a mixer, a filter, and an amplifier, and transmit and receive wireless signals via the antenna 2437. The wireless communication interface 2433 may be a chip module on which the BB processor 2434 and the RF circuit 2435 are integrated. As shown in FIG. 23, the wireless communication interface 2433 may include multiple BB processors 2434 and multiple RF circuits 2435. Although FIG. 23 shows an example in which the wireless communication interface 2433 includes multiple BB processors 2434 and multiple RF circuits 2435, the wireless communication interface 2433 may include a single BB processor 2434 or a single RF circuit 2435.

In addition to the cellular communication scheme, the wireless communication interface 2433 may support another type of wireless communication scheme, such as a short-range wireless communication scheme, a near field communication scheme, or a wireless LAN scheme. In this case, the wireless communication interface 2433 may include a BB processor 2434 and an RF circuit 2435 for each wireless communication scheme.

Each of the antenna switches 2436 switches a connection destination of the antenna 2437 among multiple circuits, such as circuits for different wireless communication schemes, included in the wireless communication interface 2433.

Each of the antennas 2437 includes a single or multiple antenna elements (such as multiple antenna elements included in a MIMO antenna), and is used for the wireless communication interface 2433 to transmit and receive wireless signals. As shown in FIG. 23, the vehicle navigation device 2420 may include multiple antennas 2437. Although FIG. 23 shows an example in which the vehicle navigation device 2420 includes multiple antennas 2437, the vehicle navigation device 2420 may include a single antenna 2437.

In addition, the vehicle navigation device 2420 may include antenna(s) 2437 for each wireless communication scheme. In this case, the antenna switches 2436 may be omitted from the configuration of the vehicle navigation device 2420.

The battery 2438 supplies power to each block of the vehicle navigation device 2420 shown in FIG. 23 via a feeder line. The feeder line is partially shown as a dashed line in the figure. The battery 2438 accumulates electric power supplied from the vehicle.

In the vehicle navigation device 2420 shown in FIG. 23, the first determination unit 510, the second determination unit 520, the third determination unit 530, the candidate time slot determination unit 550 and the sensing unit 560 described by using FIG. 5, the position determination unit 910, the sensing unit 920 and the resource determination unit 930 described by using FIG. 9, and the determination unit 1210, the sensing unit 1220, the generation unit 1230, the position determination unit 1250 and the resource determination unit 1260 described by using FIG. 12 may be implemented through the processor 2421. At least part of the functions may be implemented by the processor 2421. For example, the processor 2421 may perform, by executing instructions stored in the memory 2422, the functions of determining the position of the predetermined time slot to be listened to, determining the position of the time slot needed to be listened to, determining the position of the time slot actually to be listened to, determining the candidate time slots, sensing the time slots, determining the resources used for sidelink transmission, determining which periods needs the resource occupancy check, and generating the information indicating that no resource occupancy check is performed on the periodically occupied resources or information including priority of the resources.

The technology of the present disclosure may also be implemented as an in-vehicle system (or vehicle) 2440 including the vehicle navigation apparatus 2420, a vehicle-mounted network 2441, and one or more blocks of vehicle modules 2442. The vehicle modules 2442 generate vehicle data (such as vehicle speed, engine speed, and failure information), and outputs the generated data to the vehicle-mounted network 2441.

Preferred embodiments of the present disclosure are described above with reference to the drawings. However, the present disclosure is not limited to the above examples. Those skilled in the art may make various alternations and modifications within the scope of the appended claims. It should be understood that these alternations and modifications shall naturally fall within the technical scope of the present disclosure.

For example, units shown by a dotted line block in the functional block diagram shown in the drawings indicate that the functional units are optional in the corresponding device, and the optional functional units may be combined appropriately to achieve required functions.

For example, multiple functions implemented by one unit in the above embodiments may be implemented by separate apparatus. Alternatively, multiple functions implemented by multiple units in the above embodiments may be implemented by separate apparatus, respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in other order appropriately.

Although the embodiments of the present disclosure are described in detail above with reference to the accompanying drawings, it should be understood that the embodiments are only for illustrating the present disclosure and do not constitute a limitation of the present disclosure. For those skilled in the art, various modifications and changes can be made to the embodiments without departing from the spirit and scope of the present disclosure. Therefore, the scope of the present disclosure is limited by only the appended claims and equivalents thereof.

1. Electronic equipment, comprising processing circuitry configured to:
determine a position of a predetermined time slot to be listened to according to a period of periodic partial sensing;
determine a position of a time slot needed to be listened to according to a data transmission period of the electronic equipment; and
determine a position of a time slot actually to be listened to according to the position of the predetermined time slot to be listened to and the position of the time slot needed to be listened to, so that the position of the time slot actually to be listened to includes the position of the predetermined time slot to be listened to and the position of the time slot needed to be listened to.

2. The electronic equipment according to claim 1, wherein the processing circuitry is further configured to:
receive, from network side equipment, a period of the periodic partial sensing and a position indication of the periodic partial sensing which are configured by the network side equipment; and
determine the position of the predetermined time slot to be listened to according to the period of the periodic partial sensing and the position indication of the periodic partial sensing.

3. The electronic equipment according to claim 2, wherein the processing circuitry is further configured to:
determine one or more candidate time slots in a resource selection window; and
use, for each candidate time slot, a time slot before the candidate time slot and at a distance from the candidate time slot of a first predetermined number of time slots, as the predetermined time slot to be listened to, the first predetermined number being a result obtained by multiplying the period of the periodic partial sensing by the position indication of the periodic partial sensing.

4. The electronic equipment according to claim 2, wherein the processing circuitry is further configured to:
determine the position of the time slot needed to be listened to according to the data transmission period of the electronic equipment and the position indication of the periodic partial sensing.

5. The electronic equipment according to claim 4, wherein the processing circuitry is further configured to:
determine one or more candidate time slots in a resource selection window; and
use, for each candidate time slot, a time slot before the candidate time slot and at a distance from the candidate time slot of a second predetermined number of time slots, as the time slot needed to be listened to, the second predetermined number being a result obtained by multiplying the data transmission period of the electronic equipment by the position indication of the periodic partial sensing.

6. The electronic equipment according to claim 2, wherein the period of the periodic partial sensing comprises one or more periods selected from periods supported by a resource pool, and the position indication of the periodic partial sensing comprises one or more position indications.

7. The electronic equipment according to claim 1, wherein the processing circuitry is further configured to:
execute the periodic partial sensing to perform listening at the position of the time slot actually to be listened to, to use free resources for sidelink transmission.

8. Electronic equipment, comprising processing circuitry configured to:
determine, in a case where the number of candidate time slots in a resource selection window is less than a predetermined threshold, a position of a time slot to be listened to according to positions of the candidate time slots and a period of periodic partial sensing;
execute the periodic partial sensing to perform listening at the position of the time slot to be listened to, to determine free resources in the candidate time slots; and
determine resources to be used for sidelink transmission from the free resources in the candidate time slots.

9. The electronic equipment according to claim 8, wherein the processing circuitry is further configured to:
perform listening at the position of the time slot to be listened to through a physical layer, to determine free resources in the candidate time slots;
send the free resources in the candidate time slots to an MAC layer through the physical layer; and
determine, through the MAC layer, the resources to be used for sidelink transmission from the free resources in the candidate time slots.

10. The electronic equipment according to claim 9, wherein the processing circuitry is further configured to:
send the number of the candidate time slots to the MAC layer through the physical layer.

11. The electronic equipment according to claim 8, wherein the processing circuitry is further configured to:
determine one or more extra time slots in the resource selection window so that a sum of the number of the candidate time slots and the number of the extra time slots is greater than or equal to the predetermined threshold;
determine partial resources in the extra time slots; and
determine resources to be used for sidelink transmission from the free resources in the candidate time slots and the partial resources in the extra time slots.

12. The electronic equipment according to claim 11, wherein the processing circuitry is further configured to:
determine the extra time slots in the resource selection window through a physical layer;
determine the partial resources in the extra time slots through the physical layer;
send the free resources in the candidate time slots and the partial resources in the extra time slots to an MAC layer through the physical layer; and
determine, through the MAC layer, the resources to be used for sidelink transmission from the free resources in the candidate time slots and the partial resources in the extra time slots.

13. The electronic equipment according to claim 12, wherein the processing circuitry is further configured to:
send indication information indicating whether each resource belongs to the candidate time slots or the extra time slots to the MAC layer through the physical layer.

14. Electronic equipment, comprising processing circuitry configured to:
reuse, in each data transmission period, periodically occupied resources for sidelink transmission;
perform, before reusing the periodically occupied resources in part of the data transmission periods, a resource occupancy check on the periodically occupied resources to determine whether the periodically occupied resources are free; and
in the other part of the data transmission periods, perform no resource occupancy check on the periodically occupied resources, and generate information indicating that the electronic equipment performs no resource occupancy check on the periodically occupied resources, or increase a priority of data packets sent by reusing the periodically occupied resources.

15. The electronic equipment according to claim 14, wherein the processing circuitry is further configured to:
perform, before reusing the periodically occupied resources in the part of the data transmission periods, periodic partial sensing on the periodically occupied resources, and determine whether the periodically occupied resources are free based on a result of the resource occupancy check and a result of the periodic partial sensing.

16. The electronic equipment according to claim 15, wherein the processing circuitry is further configured to:
determine a position of a time slot to be listened to during the periodic partial sensing according to positions of time slots of the periodically occupied resources in the data transmission period.

17. The electronic equipment according to claim 15, wherein the processing circuitry is further configured to:
in the resource occupancy check, make a distance between a start time of the resource occupancy check and a time of reusing the periodically occupied resources greater than or equal to a predetermined threshold.

18. The electronic equipment according to claim 14, wherein the processing circuitry is further configured to:
perform resource re-selection in a case where it is determined that the periodically occupied resources are not free.

19. The electronic equipment according to claim 14, wherein the processing circuitry is further configured to:
send the information via sidelink control information SCI, in each data transmission period in the other part of the data transmission periods and/or in a data transmission period before each data transmission period in the other part of the data transmission periods.

20.-39. (canceled)
